(19) United States
(12) Patent Application Publication
(10) Pub. No.: US 2023/0383074 A1
(43) Pub. Date: Nov. 30, 2023

(54) MULTILAYERED POLYVINYL ALCOHOL FILMS AND METHODS FOR MAKING SAME

(71) Applicant: MONOSOL, LLC, Merrillville, IN (US)

(72) Inventors: Akio Nishimi, Abiko City (JP); Richard Goetz, Merrillville, IN (US); Jason Romine, Merrillville, IN (US)

(21) Appl. No.: 18/142,885

(22) Filed: May 3, 2023

Related U.S. Application Data
(60) Provisional application No. 63/337,956, filed on May 3, 2022.

(51) Int. Cl. C08J 5/18; C08J 9/12

(52) U.S. Cl. CPC C08J 5/18; C08J 9/125; C08J 2301/28; C08J 2329/04

(57) ABSTRACT

Disclosed herein are a simultaneous co-casting process for preparing a multilayer water-soluble film, multilayer films prepared by a simultaneous co-casting process, multilayer films including a foamed layer, methods of making thereof, related articles made therefrom, and related uses thereof.

### CROSS-REFERENCE TO RELATED APPLICATION

The benefit under 35 U.S.C. § 119(e) of U.S. Provisional Patent Application No. 63/337,956, filed May 3, 2022, is claimed and the entire disclosure thereof is incorporated herein by reference.

### FIELD OF THE INVENTION

The present disclosure relates generally to water-soluble films and related packets. More particularly, the disclosure relates to multilayered, water-soluble, polyvinyl alcohol films and simultaneous casting processes for making such films.

### BACKGROUND

Water-soluble polymeric films are commonly used as packaging materials to simplify dispensing, pouring, dissolving, and dosing of a material to be delivered. A consumer can directly add the pouched composition to a mixing vessel, such as a bucket, sink, or washing machine. Advantageously, this provides for accurate dosing while eliminating the need for the consumer to measure the composition. Additionally, the water-soluble polymeric film packaging can separate otherwise strong chemistries from the consumer's hand, protecting the consumer from coming in contact with harsh chemicals. The pouched composition may also reduce mess that would be associated with dispensing a similar composition from a vessel, such as pouring a composition from a bottle. In sum, soluble pre-measured polymeric film pouches provide for the convenience and safety of consumer use in a variety of applications.

Some water-soluble polymeric films that are used to make currently marketed pouches interact with other pouches (i.e., blocking), are not visually appealing due to having a high haze %, or do not exhibit high enough sealability, or solubility, e.g., after storage. For example, pouches may demonstrate low haze % but block with other pouches too easily. Or pouches may demonstrate good solubility but poor water sealability, such as commonly used water-soluble films, e.g., certain polyvinyl alcohol films. Films that demonstrate poor water sealability can undergo premature breaking of the pouch or packet seal, and release of the contents prior to use. In another type of problem, pouches may demonstrate good sealability but poor solubility in cold water. Such reduced solubility can, for example, result in significant amounts of residue remaining (e.g., greater than 50%) after the contents of the pouch have been dispersed. Additionally, chemical incompatibility of the film comprising a pouch with one or more materials packaged therein can lead to undesirable interactions or chemical reactions. For instance, interaction of the film comprising a pouch with a material enclosed therein can result in degradation or failure of the film, leading to leakage of the pouch contents; degradation of the pouch contents; generation of gaseous side products, possibly leading to rupture of the pouch; or crosslinking of the film, which can result in film cracking during storage.

In some instances, modifying a water-soluble film to improve one property can have a negative impact on other properties. For example, an anti-blocking agent may be incorporated into a film or applied to a film surface in order to improve the film's blocking properties, but addition of such anti-blocking agents typically increases the haziness of the film. It would be advantageous to produce water-soluble films which can provide a combination of beneficial chemical and/or physical properties which typically run counter to each other.

Multilayer polyvinyl alcohol films have been made by melt co-extrusion, e.g., as in U.S. Pat. No. 8,597,796 B2. For solution casting, it has been described that a first casting step is followed by a drying process to remove carrier solvents before casting a second layer to form a bilayer film, e.g., as in U.S. Patent Application Publication No. 2009/0196908 A1, U.S. Pat. Nos. 4,765,916 and 9,744,695 B2, and international (PCT) publication WO 1998/021118 A1, the disclosures of which are hereby incorporated by reference. Prior literature also describes laminating two films or by sequential casting, to create a multilayer construct, e.g., as in U.S. Pat. No. 6,776,287, the disclosure of which is hereby incorporated by reference.

### SUMMARY

One aspect of the disclosure provides a water-soluble film comprising multiple layers which are in continuous contact with each other, wherein the film is prepared by a simultaneous solution co-casting process.

Another aspect of the disclosure provides a multilayer water-soluble film including a first layer which contains a blend of a polyvinyl alcohol (PVOH) homopolymer and a PVOH copolymer and a second layer which includes a blend of PVOH homopolymers. A film according to this aspect optionally can simultaneously provide both a high barrier to moisture vapor transmission and good sealing performance.

Another aspect of the disclosure provides a multilayer water-soluble film wherein the amount of an anti-blocking agent in a first layer of the film, as a percentage of the total weight of the first layer, is higher than the amount of anti-blocking agent in a second layer of the film, as a percentage of the total weight of the second layer.

Another aspect of the disclosure provides a multilayer water-soluble film including a first layer which contains a bio-based resin and a second layer which contains a PVOH homopolymer, a PVOH copolymer, or a blend thereof.

Another aspect of the disclosure provides a method for producing a multilayer water-soluble film, such as a bilayer film, by a simultaneous solution co-casting process.

For the compositions and methods described herein, optional features, including but not limited to components and compositional ranges thereof, are contemplated to be selected from the various aspects, embodiments, claims, and Examples provided herein. For example, features of the embodiments and formulation approaches described in Examples 1 to 7 can be combined with any of the additional features provided in the description and claims herein.

Further aspects and advantages will be apparent to those of ordinary skill in the art from a review of the following detailed description. While the film and process of the disclosure are susceptible of embodiments in various forms, the description hereafter includes specific embodiments with the understanding that the disclosure is illustrative and is not intended to limit the invention to the specific embodiments described herein.

### BRIEF DESCRIPTION OF THE DRAWINGS

For further facilitating the understanding of the present disclosure, eight figures are appended hereto. The figures herein are illustrative in nature and are not intended to be limiting.

FIGS. 1 and 2 are graphs of static coefficient of friction (COF) vs. haze % for monolayer and bilayer films described herein.

FIG. 3 is a perspective view of a multi-slot die that can be used to prepare co-cast bilayer films.

FIGS. 4A and 4B show the die of FIG. 3 in side view. FIG. 4B shows an enlargement of the circled portion of FIG. 4A.

FIG. 5 shows a schematic view to illustrate the die angle with respect to a casting surface.

FIG. 6 shows a perspective view of a Coefficient of Friction Testing Fixture used in Example 2.

FIG. 7 shows optical microscopy cross-sectional views of a multilayer co-cast film 3C described in Example 3.

FIG. 8 shows optical microscopy cross-sectional views of a multilayer sequentially cast film described in Example 3.

### DETAILED DESCRIPTION

One aspect of the disclosure provides a water-soluble film comprising multiple layers which are in continuous contact with each other, wherein the film is prepared by a simultaneous solution co-casting process. The film of this aspect, i.e., a multilayer water-soluble film, includes multiple layers comprising a water-soluble resin, wherein each water-soluble resin independently comprises one or more polymers selected from polyvinyl alcohol homopolymers, polyvinyl alcohol copolymers, and combinations thereof. Each layer may further include one or more secondary components, as described herein.

The multilayer water-soluble film of this aspect can comprise two layers. The first layer can comprise a first water-soluble resin which can comprise a polyvinyl alcohol homopolymer, a polyvinyl alcohol copolymer, or a combination thereof, and the second layer can comprise a second water-soluble resin which can comprise a polyvinyl alcohol homopolymer, a polyvinyl alcohol copolymer, or a combination thereof. Optionally, the second water-soluble resin can be different from the first water-soluble resin. In other options, the water-soluble film can contain a first layer which comprises a water-soluble cellulose, e.g., hydroxypropyl methylcellulose, and a second layer which comprises a polyvinyl alcohol resin which can be a polyvinyl alcohol homopolymer, a polyvinyl alcohol copolymer, or a blend thereof.

For a film in which the first and/or second water-soluble resin comprises a blend of a polyvinyl alcohol homopolymer and a polyvinyl alcohol copolymer, the amounts of polyvinyl alcohol homopolymer and polyvinyl alcohol copolymer comprising the first and/or second water-soluble resin are not particularly limited. Optionally, the first water-soluble resin can comprise a polyvinyl alcohol homopolymer in an amount in a range of about 20 wt. % to about 70 wt. %, or about 25 wt. % to about 60 wt. %, or about 30 wt. % to about 50 wt. %, or about 35 wt. % to about 45 wt. %, based on the total weight of the first layer. Optionally, the first water-soluble resin can comprise a polyvinyl alcohol copolymer in an amount in a range of about 5 wt. % to about 50 wt. %, or about 10 wt. % to about 40 wt. %, or about 15 wt. % to about 35 wt. %, or about 20 wt. % to about 30 wt. %, based on the total weight of the first layer. Optionally, the second water-soluble resin can comprise a polyvinyl alcohol homopolymer in an amount in a range of about 20 wt. % to about 70 wt. %, or about 25 wt. % to about 60 wt. %, or about 30 wt. % to about 50 wt. %, or about 35 wt. % to about 45 wt. %, based on the total weight of the second layer. Optionally, the second water-soluble resin can comprise a polyvinyl alcohol copolymer in an amount in a range of about 5 wt. % to about 50 wt. %, or about 10 wt. % to about 40 wt. %, or about 15 wt. % to about 35 wt. %, or about 20 wt. % to about 30 wt. %, based on the total weight of the second layer. Optionally, the amount of polyvinyl alcohol homopolymer comprising the first water-soluble resin is greater than or equal to the amount of polyvinyl alcohol copolymer comprising the first water-soluble resin.

The multilayer water-soluble film of this aspect can have any suitable thickness. For instance, the water-soluble film can have a thickness in a range of about 15 microns to about 150 microns. Each layer comprising the water-soluble film can have any suitable thickness. For instance, each layer can independently have a thickness in a range of about 1 micron to about 100 microns. The relative thickness of the layers comprising the multilayer film is not particularly limited. For instance, the ratio of the thicknesses of the first and second layers of a multilayer film of the disclosure can be in a range from about 1:200 to about 200:1, or from about 1:100 to about 100:1, or about 1:20 to about 20:1, or about 1:5 to about 5:1, or about 1:2 to 2:1, or about 1:1.

Optionally, the multilayer water-soluble film according to the disclosure can include one or more non-water-soluble layers. The non-water-soluble layer(s) may include a backing layer or a release layer in contact with the multilayer water-soluble film and may facilitate release of the multilayer water-soluble film, such as when winding the water-soluble film into a roll. Suitable non-water-soluble layers may comprise polymers including but not limited to polyethylene, polypropylene, polyethylene terephthalate, and combinations thereof.

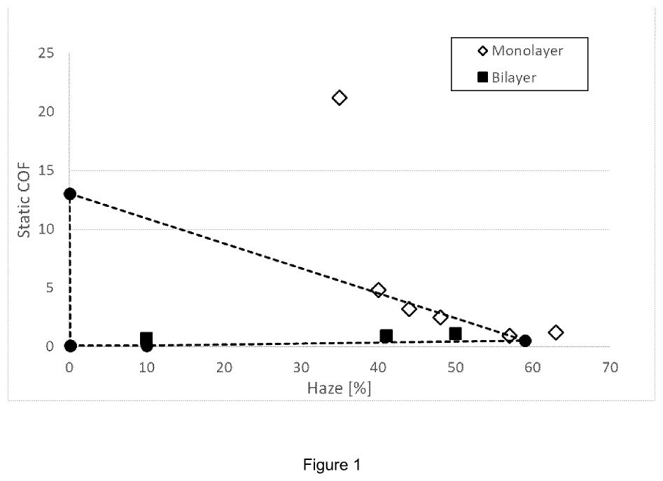

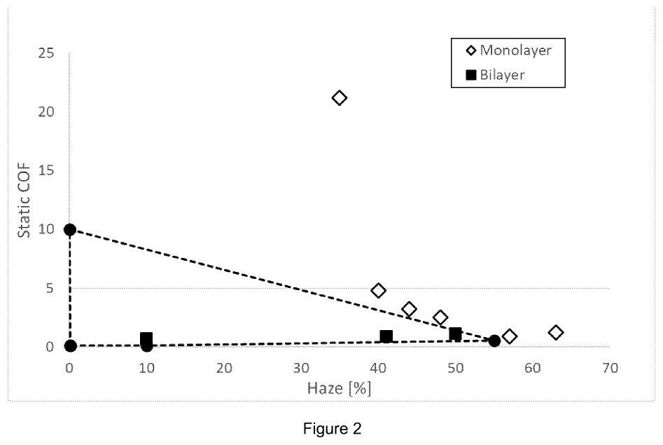

Another aspect of the disclosure provides a multilayer water-soluble film wherein the amount of one or more anti-blocking agents in a first layer of the film, as a percentage of the total weight of the first layer, is higher than the amount of anti-blocking agent in a second layer of the film, as a percentage of the total weight of the second layer. Optionally, the second layer can be free of anti-blocking agents, substantially free of anti-blocking agents, or have a lower concentration of anti-blocking agents compared to the first layer. Optionally, the first layer comprises the gloss surface of the film, i.e., the surface in contact with air during drying. A film according to this aspect can be designed to simultaneously exhibit a combination of both low coefficient of friction and low haze, e.g., a coefficient of friction corresponding to the layer containing the one or more anti-blocking agents, when disposed as an outer surface of the multilayer film, and a haze value characteristic of the entire multilayer film thickness. For instance, a film according to this aspect can exhibit a combination of haze (%) and static coefficient of friction (“COF”) that lies within a polygon defined by the vertices (haze (%), static COF) of about (0.03, 13), about (59, 0.5), about (10, 0.1) and about (0.1, 0.1). FIG. 1 shows a plot of this polygon, illustrated as a dotted line, and also shows (haze (%), static COF) points for monolayer films and bilayer films according to the Examples described herein. Optionally, a film according to this aspect can exhibit a combination of haze (%) and static coefficient of friction (“COF”) that lies within a polygon defined by the vertices (haze (%), static COF) of about (0.03, 10), about (55, 0.5), about (10, 0.1) and about (0.1, 0.1). FIG. 2 shows a plot of this polygon, illustrated as a dotted line, and also shows (haze (%), static COF) points for monolayer films and bilayer films according to the Examples described herein. The one or more anti-blocking agents in the first layer can impart a low coefficient of friction to this layer. However, because the multilayer film of this aspect can contain anti-blocking agent preferentially, predominantly, or only, in one layer, the multilayer film can be designed to exhibit lower haze compared to a film which contains the same concentration of anti-blocking agent throughout the cross-section of the film. Thus, the film takes advantage of the property that the coefficient of friction is a characteristic essentially of the outer surface of the film, such that the entire film thickness need not contain anti-blocking agent in order to render a surface of the film with a low coefficient of friction. A multilayer film of this aspect can accordingly be designed to exhibit equivalent coefficient of friction but reduced haze compared to a single-layer film having the same concentration of anti-block agents. Alternatively, a multilayer film of this aspect can be designed to exhibit a superior, reduced coefficient of friction and equivalent haze compared to a single-layer film containing the same concentration of anti-block agents.

Another aspect of the disclosure provides a multilayer water-soluble film including a first layer which contains a blend of a PVOH homopolymer and a PVOH copolymer and a second layer which includes a PVOH homopolymer or blend of PVOH homopolymers. A film according to this aspect can provide a high barrier to moisture vapor transmission as a result of the PVOH copolymer-containing layer and good sealing performance as a result of the PVOH homopolymer layer, i.e., a high seal strength when a first portion of the film is heat-sealed to a second portion of the film, or separate such films are sealed to each other. The first portion and second portion can be sealed wherein a surface of a layer comprising a blend of a PVOH homopolymer and a PVOH copolymer is sealed to a surface of a layer comprising a PVOH homopolymer or blend of PVOH homopolymers.

Another aspect of the disclosure provides a multilayer water-soluble film including a first layer which contains a bio-based resin and a second layer which contains a PVOH homopolymer, a PVOH copolymer, or a blend thereof.

Another aspect of the disclosure provides a multilayer water-soluble film including a top layer comprising a foamed film.

The multilayer water-soluble film according to the disclosure can be free of an interlayer, such as a bonding agent, between layers, such as between the first and second layers of a bilayer film.

A water-soluble film having the same composition and thickness as the first layer of a multilayer film of the disclosure can have a dissolution time at 20° C. of 300 seconds or less, or 200 seconds or less, based on the MSTM 205 test method described herein.

The multilayer water-soluble film according to the disclosure can have a second layer comprising an outer surface and the film, when sealed to itself by a first portion of the second layer outer surface being sealed to a second portion of the second layer outer surface, can have a water seal strength in a range of about 5 N to about 18 N, or about 10 N to about 18 N, or about 12 N or more, based on the Seal Strength Test described herein.

The multilayer water-soluble film according to the disclosure can have a second layer comprising an outer surface, and the film, when sealed to itself by a first portion of the second layer outer surface being sealed to a second portion of the second layer outer surface, can have a water seal strength in a range of about 10 N or more, or about 12 N or more, or about 15 N or more, based on the Seal Strength Test described herein, and a moisture vapor transmission rate of about 100 g/m² or less per 24 hours, or about 50 g/m² or less per 24 hours, or about 30 g/m² or less per 24 hours, based on the Moisture Vapor Transmission Rate test method described herein.

The disclosure also provides a co-casting process for producing a multilayer water-soluble film, wherein the process comprises simultaneously casting multiple resin solutions to form a multilayer solution composition comprising layers of the multiple resin solutions and drying the multilayer solution composition to form a multilayer film. Multilayer films produced according to the co-casting process of the disclosure can provide one or more advantageous properties compared to multilayer films produced according to a sequential casting process, wherein a multilayer film is constructed by solution-casting a second layer, at least partially drying the second layer by application of heat to form a film, solution-casting a first layer in contact with the second film, and drying the layers to form a multilayer film. The co-casting process of the disclosure can be used to provide a multilayer film in fewer steps than a sequential cast process. Furthermore, advantageously each layer of a multilayer film produced by the co-casting process of the disclosure will experience the same heat history, while each layer of a multilayer film produced by a sequential casting process would experience a different heat history due to the multiple heat-drying steps comprising a sequential casting process, e.g., wherein the first-cast layer experiences a longer heating and drying time because it experiences excess heating to allow the second-cast layer to dry. Without intending to be bound by theory, the simultaneous solution co-casting process according to the disclosure allows for limited migration of adjacent layers into each other so as to more effectively bind adjacent layers and minimize the risk of cohesive failure in the multilayer film.

The simultaneous solution co-casting process of the disclosure can be used to produce a textured film. In particular, inserts to the multi-slot die described herein can be used during simultaneous solution co-casting to create stripes in the top layer of a multilayer film.

Another aspect of the disclosure provides a water-soluble unit dose article. The unit dose article can comprise a pouch comprising an outer wall, the outer wall having an exterior surface and an interior surface defining an interior pouch volume, wherein the outer wall comprises a multilayer water-soluble film of the disclosure. Optionally, the interior pouch volume can contain a composition. The multilayer film comprising the unit dose article of this aspect can be selected to provide an article with useful properties that are derived from the properties of the component film layers. For instance, a multilayer film can be designed to include a first layer which provides a high barrier to moisture vapor transmission and a second layer which exhibits high seal strength, e.g., when sealed to itself. Such a multilayer film can be useful for constructing a water-soluble unit dose article, for instance, by sealing a first portion of the second layer to a second portion of the second layer to form a pouch which can contain a composition. An article constructed from such a multilayer film is expected to exhibit a low risk of seal failure (i.e., a low risk of breaking prematurely) while also preventing moisture from reaching a composition contained therein.

Another aspect of the disclosure provides a water-soluble unit dose article comprising multiple compartments, wherein the unit dose article comprises one or more multilayer films of the present disclosure. The unit dose article can comprise a first and a second sealed compartment. The second compartment can be in a generally superposed relationship with the first sealed compartment such that the second sealed compartment and the first sealed compartment share a partitioning wall interior to the pouch. A unit dose article comprising a first and a second sealed compartment can further comprise a third sealed compartment. The third sealed compartment can be in a generally superposed relationship with the first sealed compartment such that the third sealed compartment and the first sealed compartment share a partitioning wall interior to the pouch. The film of the first compartment can be a multilayer film of the present disclosure. The film of the second compartment can be a multilayer film of the present disclosure. The film of the partitioning wall can be a multilayer film of the present disclosure. The films of the first and second compartments can be multilayer films of the present disclosure. The films of the first and second compartments, and of the partitioning wall, can be multilayer films of the present disclosure.

Unit dose articles comprising multiple compartments wherein the unit dose article comprises one or more multilayer films of the present disclosure can be made according to a process comprising the steps of (a) forming a first compartment comprising a first film; (b) forming a recess within part or all of the closed first compartment formed in step (a), to generate a second molded compartment comprising a second film superposed above the first compartment; (c) filling and closing the second compartment by means of a third film; (d) sealing the first, second and third films; and (e) cutting the films to produce a multi-compartment pouch. The recess formed in step (b) may be achieved by applying a vacuum to the compartment prepared in step (a). The first water-soluble film can be a multilayer film of the present disclosure. The second water-soluble film can be a multilayer film of the present disclosure. The third water-soluble film can be a multilayer film of the present disclosure. The first and second water-soluble films can be multilayer films of the present disclosure. The first and third water-soluble films can be multilayer films of the present disclosure. The first, second and third water-soluble films can be multilayer films of the present disclosure.

The different compartments of a multi-compartment article wherein the article comprises one or more multilayer films of the present disclosure may be made together in a side-by-side style or concentric style, wherein the resulting, cojoined pouches may or may not be separated by cutting. Alternatively, the compartments can be made separately.

Another method of producing a unit dose article comprising multiple compartments wherein the unit dose article comprises one or more multilayer films of the present disclosure can include: (a) deforming a first water-soluble film in a mold to create an open cavity; (b) filling the open cavity formed by the first water-soluble film with a composition; (c) separately deforming a third water-soluble film in a mold to create at least one open cavity; (d) filling the at least one open cavity in the third film with a composition (e.g., that is the same or different from the composition of step (b)); (e) closing the open filled cavity or cavities of step (d) with a second water-soluble film; (f) sealing the second water-soluble film and third water-soluble film, optionally via solvent sealing, to create a closed intermediate; (g) closing the open filled cavity of step (b) with the closed intermediate of step (f); and (h) sealing the first water-soluble film and the second water-soluble film of the closed intermediate of step (g), optionally via solvent sealing, to create the water-soluble unit dose article. Use of this method can provide, for example, a unit dose article having compartments of compositions that are superposed, e.g., one or more compartments superposed with respect to another compartment. Any one of the sealing steps can comprise solvent sealing, and at least one of the sealing steps can include solvent sealing. Each of the first and the second water-soluble film has a first side and a second side, and the first side of the first water-soluble film can be sealed to the second side of the second water-soluble film to create a first compartment between the first water-soluble film and the second water-soluble film, and the first side of the second water-soluble film can be sealed to the second side of the third water-soluble film to create at least a second compartment between the second water-soluble film and the third water-soluble film, and the second compartment can be positioned above the first compartment. The first water-soluble film and the third water-soluble film can be identical prior to thermoforming, i.e., physically and chemically identical, wherein the term ‘identical’ means within standard processing of making specification variations. Optionally, the sealing of the first water-soluble film and the second water-soluble film can include a step of wetting the second water-soluble film with a sealing solution as described herein, e.g., via a contact wetting method. In addition or in the alternative, the sealing of the second water-soluble film and the third water-soluble film optionally can include a step of wetting the second water-soluble film with a sealing solution as described herein, e.g., via a contact wetting method. The first water-soluble film can be a multilayer film of the present disclosure. The second water-soluble film can be a multilayer film of the present disclosure. The third water-soluble film can be a multilayer film of the present disclosure. The first and second water-soluble films can be multilayer films of the present disclosure. The first and third water-soluble films can be multilayer films of the present disclosure. The first, second and third water-soluble films can be multilayer films of the present disclosure.

The water-soluble unit dose articles comprising multiple compartments, including those having a superposed configuration, can optionally contain, in one or more compartments, a fabric and home care composition. Fabric and home care compositions include fabric treatments, treatments for hard surfaces and any other surfaces in the area of fabric and home care, air care, car care, dishwashing, fabric conditioning and softening, laundry detergency, laundry and rinse additive and/or care, hard surface cleaning and/or treatment, and other cleaning for consumer or institutional use.

Fabric and home care products are optionally used or consumed in the form in which they are sold and are for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for fabric or home use.

Cleaning and/or treatment compositions include, but are not limited to, products for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for fabric and household use: car or carpet shampoos, bathroom cleaners including toilet bowl cleaners; as well as cleaning auxiliaries such as bleach additives and “stain-stick” or pre-treat types, substrate-laden products such as dryer added sheets.

Fabric and/or hard surface cleaning and/or treatment compositions include, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, car or carpet shampoos, bathroom cleaners including toilet bowl cleaners; fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets. All of such products which are applicable may be in standard, concentrated or even highly concentrated form even to the extent that such products may in certain aspects be non-aqueous.

Optionally, the multilayer water-soluble film according to the disclosure can include one or more active ingredients. The one or more active ingredients may be present throughout the film or one or more layers thereof, deposited on one or both surfaces of the film, or both. Suitable active ingredients include but are not limited to cleaning agents, detergents, superabsorbents, water softeners, stain removers, fabric softeners, color protectors, enzymes, fragrance, odor-removing agents, polishing agents, disinfectants, peroxide and other bleaching agents including but not limited to hypochlorites, hydroxides, chloramines, chloramines, chloramides, and chlorimides, and personal care/hygiene products, including but not limited to shampoos, skin cleansers, exfoliants, and teeth cleansers. Suitable active ingredients can also include ingredients which can inhibit or suppress crosslinking, e.g., sodium acetate.

A multilayer water-soluble film according to the disclosure can be designed to reduce or eliminate detrimental interaction between a unit-dose article, such as a pouch, and contents of the article. A multilayer water-soluble film according to the disclosure can be prepared such that one layer of the film is enriched in a component relative to one or more other layers of the film. A unit-dose article comprising one or more compartments can be constructed from such a film such that the inner surface of a compartment of the unit-dose article, i.e., the surface disposed adjacent to or in direct contact with contents of the compartment, comprises the film layer that is enriched in a component. For instance, a multilayer water-soluble film can be constructed in which one layer of the film is enriched in a low-molecular weight polyol, for example one or more of glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, polyether polyols, sorbitol, methylpropanediol, 2-methyl-1,3-propanediol (MPDiol®), or a combination thereof. A unit-dose article can be constructed from such a film such that the film layer that is enriched in a low-molecular weight polyol forms the inner surface of one or more compartments of the unit-dose article. In such a configuration, the polyol in the inner film surface is available, for instance, for crosslinking with a material in the pouch contents, for example including but not limited to aldehydes (e.g., glutaraldehyde), acids and polyacids (e.g., citric acid), or sodium borate. Such crosslinking can advantageously improve rigidity of the packaging film. This use of a low-molecular weight polyol can be considered a sacrificial use, e.g., whereby the polyol is for crosslinking rather than its typical use of plasticization of the film layer. Such crosslinking can also mitigate undesired chain scission of the polymer film, which can occur in films that are used to package oxygenated bleaches.

All percentages, parts and ratios referred to herein are based upon the total dry weight of the film composition or total weight of the packet content composition of the present disclosure, as the case may be, and all measurements made are at about 25° C., unless otherwise specified. All such weights as they pertain to listed ingredients are based on the active level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

It is expressly contemplated that for any number value described herein, e.g., as a parameter of the subject matter described or part of a range associated with the subject matter described, an alternative which forms part of the description is a functionally equivalent range surrounding the specific numerical value (e.g., for a dimension disclosed as “40 mm” an alternative embodiment contemplated is “about 40 mm”).

As used herein, the terms packet(s) and pouch(es) should be considered interchangeable. The terms packet(s) and pouch(es), respectively, can be used to refer to a container made using the film, and to a fully-sealed container preferably having a material sealed therein, e.g., in the form of a measured dose delivery system. The sealed pouches can be made from any suitable method, including such processes and features such as heat sealing, solvent welding, and adhesive sealing (e.g., with use of a water-soluble adhesive).

As used herein and unless specified otherwise, the terms “wt. %” and “wt %” are intended to refer to the composition of the identified element in “dry” (non-water) parts by weight of the entire film, including residual moisture in the film (when applicable, as describing a film), or parts by weight of the entire composition or coating, as the case may be depending on context.

As used herein and unless specified otherwise, the term “PHR” (“phr”) is intended to refer to the composition of the identified element in parts per one hundred parts water-soluble polymer resin(s) (whether PVOH or other polymer resins, unless specified otherwise) in the water-soluble film, or a solution used to make the film.

Methods of forming containers from films are known in the art. The film can be used to form a container (pouch) by any suitable process, including vertical form, fill, and sealing (VFFS), or thermoforming. The film can be sealed by any suitable process including, for example, solvent sealing or heat sealing of film layers, e.g., around a periphery of a container. The pouches can be used for dosing materials to be delivered into bulk water, for example.

The film, pouches, and related methods of use are contemplated to include embodiments including any combination of one or more of the additional optional elements, features, and steps further described below, unless stated otherwise.

The water-soluble pouch can contain (enclose) a composition. The composition can be selected from a liquid, solid, or combination thereof. As used herein, “liquid” includes free-flowing liquids, as well as pastes, gels, foams, and mousses. Gases, e.g., suspended bubbles, or solids, e.g., particles, may be included within the liquids. A “solid” as used herein includes, but is not limited to, powders, agglomerates, and mixtures thereof. Non-limiting examples of solids include granules, micro-capsules, beads, noodles, and pearlised balls.

For each layer of the multilayer film of the disclosure, the water-soluble resin comprising the layer can include one or more polyvinyl alcohol (PVOH) homopolymers, one or more polyvinyl alcohol copolymers, or a combination thereof. As used herein, the term “homopolymer” generally includes polymers having a single type of monomeric repeating unit (e.g., a polymeric chain consisting of or consisting essentially of a single monomeric repeating unit). For the particular case of PVOH, the term “homopolymer” (or “PVOH homopolymer”) can include copolymers consisting of a distribution of vinyl alcohol monomer units and vinyl acetate monomer units, depending on the degree of hydrolysis (e.g., a polymeric chain consisting of or consisting essentially of vinyl alcohol and vinyl acetate monomer units). In the limiting case of 100% hydrolysis, a PVOH homopolymer can include a true homopolymer having only vinyl alcohol units.

For each layer of the multilayer film of the disclosure, the water-soluble resin comprising the layer can include one or more bio-based resins. Suitable bio-based resins include, but are not limited to, cellulose ethers, cellulose esters, cellulose amides, gelatins, methylcelluloses, carboxymethylcelluloses and salts thereof, dextrins, ethylcelluloses, hydroxyethyl celluloses, hydroxypropyl methylcelluloses, maltodextrins, starches, modified starches, guar gum, acacia gum, gum arabic, xanthan gum, pullulan, carrageenan, iota carrageenan, kappa carrageenan, pea protein, chitosan, chitosan derivatives, alginates and salts thereof, and a combination of one or more of any of the foregoing. Particularly suitable bio-based resins for incorporation into multilayer films according to the disclosure are cellulosic polymers and modified celluloses, including but not limited to hydroxypropyl methylcellulose, hydroxyethyl cellulose, ethyl cellulose, methyl cellulose, carboxymethyl cellulose and its salts, and combinations thereof. Suitable bio-based resins can also include synthetic polymers derived from bio-sourced monomers, such as polylactic acid and polyethylene derived from bio-sourced ethylene. Bio-based resins can be selected from water-soluble types of resin.

Optionally, the multilayer film can include a first layer that contains a first polyvinyl alcohol resin comprising a polyvinyl alcohol homopolymer, a polyvinyl alcohol copolymer, or a combination thereof, and at least a second layer that contains a second polyvinyl alcohol resin comprising a polyvinyl alcohol homopolymer, a polyvinyl alcohol copolymer, or a combination thereof, wherein the second polyvinyl alcohol resin is different from the first polyvinyl alcohol resin.

Polyvinyl alcohol is a synthetic resin generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water, i.e., water greater than about 140° F. (about 60° C.). If a sufficient number of acetate groups are allowed to remain after the hydrolysis of polyvinyl acetate, that is the PVOH homopolymer is partially hydrolyzed, then the polymer is more weakly hydrogen-bonded, less crystalline, and is generally soluble in cold water, i.e., water less than about 50° F. (about 10° C.). As such, the partially hydrolyzed polymer is a vinyl alcohol-vinyl acetate copolymer, but is commonly referred to as PVOH homopolymer.

The viscosity (μ) of a PVOH homopolymer or copolymer is determined by measuring a freshly made PVOH solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified in the disclosure in centipoise (cPs) should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently can have a corresponding molecular weight distribution.

It is well known in the art that the viscosity of PVOH is correlated with the weight average molecular weight (M̅w) of the PVOH resin, and often the viscosity is used as a proxy for the weight average molecular weight. The PVOH resin may have a viscosity of about 1.0 to about 50.0 cPs, about 1.0 to about 40.0 cPs, or about 1.0 to about 30.0 cPs, for example about 4 cPs, 8 cPs, 15 cPs, 18 cPs, 23 cPs, or 26 cPs. The PVOH may have a viscosity of about 1.0 to about 30.0 cPs for example, about 1 cPs, 1.5 cPs, 2 cPs, 2.5 cPs, 3 cPs, 3.5 cPs, 4 cPs, 4.5 cPs, 5 cPs, 5.5 cPs, 6 cPs, 6.5 cPs, 7 cPs, 7.5 cPs, 8 cPs, 8.5 cPs, 9 cPs, 9.5 cPs, 10 cPs, 11 cPs, 12 cPs, 13 cPs, 14 cPs, 15 cPs, 17.5 cPs, 18 cPs, 19 cPs, 20 cPs, 21 cPs, 22 cPs, 23 cPs, 24 cPs, 25 cPs, 26 cPs, 27 cPs, 28 cPs, 29 cPs, 30 cPs, 31 cPs, 32 cPs, 33 cPs, 34 cPs, or 35 cPs. The PVOH resin can have a viscosity of about 21-26 cPs. The PVOH resin can have a viscosity of about 5 cPs to about 14 cPs.

The first water-soluble resin and the second water-soluble resin can each have a weight average molecular weight, and the weight average molecular weight of the first water-soluble resin can be greater than the weight average molecular weight of the second water-soluble resin. Alternatively, the first water-soluble resin and the second water-soluble resin can each have a number average molecular weight, and the number average molecular weight of the first water-soluble resin can be greater than the number average molecular weight of the second water-soluble resin.

As used herein, the degree of hydrolysis of a polyvinyl alcohol homopolymer or copolymer is expressed as a mole percentage of vinyl acetate units converted to vinyl alcohol units. The polyvinyl alcohol homopolymer or copolymer comprising the first or second water-soluble resin can independently have a degree of hydrolysis (DH) of at least about 70%, 80%, 84% or 85% and at most about 99% or 99.9%, for example in a range of about 70% to about 99.9%, about 75% to about 95%, about 85% to about 88%, about 88% to about 90%, about 84% to about 89%, about 85% to about 99.7%, about 85% to about 95%, about 87% to about 98%, about 89% to about 99%, or about 90% to about 99%, for example about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. The degree of hydrolysis, while specifically a measure of the amount of acetates removed from the polyvinyl acetate polymer (e.g., via hydrolysis or saponification), it is most commonly used to understand the amount of acetate remaining on the PVOH polymer or copolymer. The acetate groups form the amorphous or non-crystalline regions of the PVOH copolymer. Therefore, it can be stated as an approximation that the higher the DH, the relatively higher is the crystallinity of the PVOH copolymer or blends of the PVOH copolymer. When a PVOH resin is described as having (or not having) a particular DH, unless specified otherwise, it is intended that the specified DH is the average DH for the PVOH resin.

The first water-soluble resin and the second water-soluble resin can independently comprise a PVOH homopolymer, a PVOH copolymer, or a blend thereof, and the first water-soluble resin can have a degree of hydrolysis that is greater than or equal to the degree of hydrolysis of the second water-soluble resin.

The water-soluble resin comprising any layer of the multilayer film of the disclosure can include a PVOH copolymer which can be an anionic-modified polyvinyl alcohol, that is, a partially or fully hydrolyzed PVOH copolymer that includes an anionic monomer unit. The anionic-modified polyvinyl alcohol can be a PVOH terpolymer including vinyl alcohol monomer units, vinyl acetate monomer units (i.e., when not completely hydrolyzed), and a single type of anionic monomer unit (e.g., where a single type of monomer unit can include equivalent acid forms, salt forms, and optionally ester forms of the anionic monomer unit). Optionally, the first water-soluble resin can comprise an anionic-modified polyvinyl alcohol. Optionally, the second water-soluble resin can comprise an anionic-modified polyvinyl alcohol. General classes of anionic monomer units which can be used for the PVOH copolymer include the vinyl polymerization units corresponding to monocarboxylic acid vinyl monomers, esters and anhydrides thereof, dicarboxylic monomers having a polymerizable double bond, esters and anhydrides thereof, and alkali metal salts of any of the foregoing. Examples of suitable anionic monomer units include the vinyl polymerization units resulting from vinyl anionic monomers including but not limited to vinyl acetic acid, maleic acid, monoalkyl maleate, dialkyl maleate, maleic anhydride, fumaric acid, monoalkyl fumarate, dialkyl fumarate, itaconic acid, monoalkyl itaconate, dialkyl itaconate, itaconic anhydride, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, alkyl acrylates, methyl acrylate, vinyl sulfonic acids, alkali metal salts of the foregoing, esters of the foregoing, and combinations of the foregoing. The anionic monomer unit can be derived from a monomer selected from the group consisting of vinyl acetic acid, alkyl acrylates, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, itaconic acid, monomethyl itaconate, dimethyl itaconate, itaconic anhydride, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, vinyl sulfonic acid, alkyl sulfonic acid, ethylene sulfonic acid, 2-acrylamido-1-methyl propane sulfonic acid, 2-acrylamido-2-methylpropanesulfonic acid (AMPS), 2-methylacrylamido-2-methylpropanesulfonic acid, 2-sulfoethyl acrylate, hydrolyzed N-vinylpyrrolidone, alkali metal salts of the foregoing, esters of the foregoing, and combinations of the foregoing (e.g., multiple types of anionic monomer units or equivalent forms of the same anionic monomer unit).

When a water-soluble resin comprises a PVOH copolymer, the degree of modification of the PVOH copolymer is not particularly limited. For instance, the PVOH copolymer can have a degree of modification in an amount in a range of about 0.5 mol. % to about 10 mol. %, or about 1 mol. % to about 10 mol. %, about 1 mol. % to about 8 mol. %, about 1 mol % to about 5 mol %, about 2 mol. % to about 6 mol. %, about 3 mol. % to about 5 mol. %, or about 1 mol. % to about 3 mol. % (e.g., at least about 1.0, 1.5, 1.8, 2.0, 2.5, 3.0, 3.5, or 4.0 mol. % and up to about 3.0, 4.0, 4.5, 5.0, 6.0, 8.0, or 10 mol. %).

It is understood in the art that PVOH copolymers having pendant carboxyl groups, such as, for example, maleate-modified PVOH, can form lactone rings between neighboring pendant carboxyl and alcohol groups, thus reducing the water solubility of the PVOH copolymer resin. In the presence of a strong base, the lactone rings can open over the course of several weeks at relatively warm (ambient) and high humidity conditions (e.g., via lactone ring-opening reactions to form the corresponding pendant carboxyl and alcohol groups with increased water solubility). Thus, it is believed that such a PVOH copolymer film can become more soluble due to chemical interactions between the film and an alkaline composition inside the pouch during storage. The-maleate modified PVOH can be substantially free of lactone rings, such that the modified PVOH has about 2 pendant carboxylate groups per maleate monomer unit. The maleate modified PVOH can comprise about 1.5 pendant carboxylate groups to 2 pendant carboxylate groups per maleate monomer unit, or about 1.2 pendant carboxylate groups to about 2 pendant carboxylate groups per maleate monomer unit, or about 1 pendant carboxylate groups to about 2 pendant carboxylate groups per maleate monomer unit, such as, about 2 pendant carboxylate groups per maleate monomer unit, or about 1.9 pendant carboxylate groups per maleate monomer unit, or about 1.8 pendant carboxylate groups per maleate monomer unit, or about 1.7 pendant carboxylate groups per maleate monomer unit, or about 1.6 pendant carboxylate groups per maleate monomer unit, or about 1.5 pendant carboxylate groups per maleate monomer unit, or about 1.2 pendant carboxylate groups per maleate monomer unit, or about 1 pendant carboxylate groups per maleate monomer unit.

Each layer of a multilayer film of the disclosure can further include one or more water-soluble polymers including, but not limited to, polyvinyl alcohols, water-soluble acrylate copolymers, polyethyleneimine, pullulan, water-soluble natural polymers including, but not limited to, guar gum, gum Acacia, xanthan gum, carrageenan, and starch, water-soluble polymer modified starches, copolymers of the foregoing, or a combination of any of the foregoing. Yet other water-soluble polymers can include polyalkylene oxides, polyacrylamides, celluloses, cellulose ethers, cellulose esters, cellulose amides, polyvinyl acetates, polycarboxylic acids and salts thereof, polyaminoacids, polyamides, gelatins, methylcelluloses, carboxymethylcelluloses and salts thereof, dextrins, ethylcelluloses, hydroxyethyl celluloses, hydroxypropyl methylcelluloses, maltodextrins, polymethacrylates, or a combination of any of the foregoing. Such water-soluble polymers are commercially available from a variety of sources.

For each layer of the multilayer film, the water-soluble resin comprising the layer can further include a second PVOH resin. The second PVOH resin can comprise a PVOH homopolymer, PVOH copolymer, or a combination thereof. The second PVOH can comprise a PVOH copolymer comprising an anionic monomer unit as described above. The second PVOH can comprise an anionic monomer unit selected from the group of AMPS, hydrolyzed N-vinylpyrrolidone (NVP), maleic anhydride, monomethyl maleate, alkali salts thereof, and a combination thereof. The second PVOH can comprise an anionic monomer unit selected from the group of monomethyl maleate, maleic anhydride, alkali salts thereof, and a combination thereof.

Each layer of the multilayer film can optionally include, in addition to the water-soluble resin, one or more additional agents including but not limited to plasticizers, surfactants, lubricants, release agents, fillers, extenders, cross-linking agents, anti-blocking agents, detackifying agents, defoamers, nanoparticles such as layered silicate-type nanoclays, bleaching agents, antioxidants, aversive agents such as bitterants, pungents, other functional ingredients, and combinations of the foregoing, in amounts suitable for their intended purposes.

Each layer of the multilayer film can independently comprise any suitable plasticizer. A plasticizer is a liquid, solid, or semi-solid that is added to a material (usually a resin or elastomer) making that material softer, more flexible (by decreasing the glass transition temperature of the polymer), or easier to process. In addition or in the alternative, a polymer can be internally plasticized by chemically modifying the polymer or monomer. The water-soluble film described herein can comprise one or more plasticizers. The plasticizer can comprise glycerol, diglycerin, sorbitol, ethylene glycol, diethylene glycol, triethylene glycol, dipropylene glycol, tetraethylene glycol, propylene glycol, polypropylene glycol, polyethylene glycols up to 400 Da molecular weight, hexylene glycol, neopentyl glycol, trimethylolpropane, polyether polyols, polyether diol, polyether triol, xylitol, 2-methyl-1,3-propanediol (MPDiol®), ethanolamines, glycerol propylene oxide polymers (such as, for example, Voranol™ available from The Dow Chemical Company), or a mixture thereof. Lower levels (e.g., from 1 wt. % to 10 wt. %) of low molecular weight polar plasticizers, such as glycerol and/or trimethylolpropane, can be included as a means of maintaining flexibility and the ability to be converted into articles using standard equipment.

When a layer of the multilayer film includes a plasticizer, the plasticizer can be provided in a range of about 1 wt. % to about 45 wt. %, or about 5 wt. % to about 35 wt. %, or about 7.5 wt. % to about 30 wt. %, or about 8 wt. % to about 20 wt. %, or about 8 wt % to about 12 wt %, for example about 1 wt. %, 5 wt. %, 7.5 wt. %, 9 wt %, 10 wt. %, 15 wt. %, 17.5 wt % or 25 wt. %, based on total water-soluble resin weight in the layer. The amount of plasticizer can also be characterized in phr, and each layer can include a plasticizer in an amount of about 2 to about 75 phr, about 3 to about 60 phr, about 3 to about 50 phr, about 4 to about 40 phr, or about 2 to about 20 phr.

Without intending to be bound by theory, it is believed that the plasticizer can be selected to balance maintaining a flexible film and migration of active chemicals into the film matrix. Further, without intending to be bound by theory, it is believed that as the plasticization of the film increases, the ability of active chemicals to migrate into the film increases. Without intending to be bound by theory, it is believed that the closer the glass transition temperature of the film to the low end of the operating temperature range, the higher the resistance of the film to migration of chemicals into the film. Thus, the type and amount of plasticizer can be selected to provide a film having a glass transition temperature close to the low end of the operating temperature range. As used herein, the “operating temperature range” refers to the temperature at which the film will be exposed to during the life cycle of the film, for example, storage of the film and use of the film by consumers. In general, operating temperature ranges are not limited and can generally be in a range of about 0° C. to about 40° C., or about 5-10° C. to about 38-40° C.

Each layer can optionally contain other auxiliary agents and processing agents, including, but not limited to, surfactants, lubricants, release agents, fillers, extenders, cross-linking agents, anti-blocking agents, detackifying agents, antifoams (defoamers), nanoparticles such as layered silicate-type nanoclays (e.g., sodium montmorillonite), bleaching agents (e.g., sodium metabisulfite, sodium bisulfate (SBS) or others), aversive agents such as bitterants (e.g., denatonium salts such as denatonium benzoate, denatonium saccharide, and denatonium chloride; sucrose octaacetate; quinine; flavonoids such as quercetin and naringenin; and quassinoids such as quassin and brucine) and pungents (e.g., capsaicin, piperine, allyl isothiocyanate, and resinferatoxin), and other functional ingredients, in amounts suitable for their intended purposes. For example, each layer may include a filler, a surfactant, an anti-block agent, or combinations of the foregoing.

Surfactants for use in water-soluble films are well known in the art. Optionally, surfactants are included to aid in the dispersion of the resin solution upon casting. Suitable surfactants can include nonionic, cationic, anionic and zwitterionic surfactants. Suitable surfactants for each layer of the multilayer film can include, but are not limited to, polyoxyethylenated polyoxypropylene glycols, alcohol ethoxylates, alkylphenol ethoxylates, tertiary acetylenic glycols, alkanolamides, polyoxyethylenated amines, quaternary ammonium salts quaternized polyoxyethylenated amines, amine oxides, N-alkylbetaines and sulfobetaines. Suitable surfactants for each layer of the multilayer film can also include, but are not limited to, dialkyl sulfosuccinates, lactylated fatty acid esters of glycerol and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerol and propylene glycol, sodium lauryl sulfate, acetylated esters of fatty acids, myristyl dimethylamine oxide, trimethyl tallow alkyl ammonium chloride, quaternary ammonium compounds, salts thereof and combinations of any of the foregoing. Too little surfactant can sometimes result in a film having holes, whereas too much surfactant can result in the film having a greasy or oily feel from excess surfactant present on the surface of the film. Thus, surfactants optionally can be included in the water-soluble films in an amount of less than about 2 phr, for example less than about 1 phr, or less than about 0.8 phr, for example.

One type of secondary component contemplated for use is a defoamer. Defoamers can aid in coalescing of foam bubbles. Suitable defoamers for use in layers of the multilayer films according to the present disclosure include, but are not limited to, hydrophobic silicas, for example silicon dioxide or fumed silica in fine particle sizes, including Foam Blast® defoamers available from Emerald Performance Materials, including Foam Blast® 327, Foam Blast® UVD, Foam Blast® 163, Foam Blast® 269, Foam Blast® 338, Foam Blast® 290, Foam Blast® 332, Foam Blast® 349, Foam Blast® 550 and Foam Blast® 339, which are proprietary, non-mineral oil defoamers. For example, the layers of the multilayer films disclosed herein comprise Foam Blast® 338. Optionally, defoamers can be used in an amount of 0.5 phr, or less, or 0.5 phr to 0.01 phr, for example, 0.3 phr, 0.2 phr, 0.1 phr, 0.05 phr, 0.04 phr, 0.03 phr, 0.02 phr, or 0.01 phr.

Suitable fillers, extenders, and detackifying agents include, but are not limited to, starches, modified starches, crosslinked polyvinylpyrrolidone, crosslinked cellulose, microcrystalline cellulose, silica, metallic oxides, calcium carbonate, talc, mica, stearic acid and metal salts thereof, for example, magnesium stearate. Preferred materials are starches, modified starches and silica, for example, high amylose starch, amorphous silica, hydroxyethylated starch, or a combination thereof.

Aversive agents can be incorporated within each layer of the multilayer film or may be applied as a coating to the multilayer film. The aversive agent may be added in an amount to cause an aversive response such as bitterness, diluted from its commercial form or otherwise mixed with a solvent for ease in mixing with other water-soluble film components or applying as a coating to the water-soluble film. Such solvents may be selected from water, lower molecular weight alcohols (methanol, ethanol, etc.) or plasticizers disclosed herein.

An anti-block agent (e.g., silica and/or stearic acid) can optionally be present in any layer of the multilayer film of the disclosure in an amount of at least 0.1 phr, or at least 0.5 phr, or at least 1 phr, or in a range of about 0.1 to 8.0 phr, or about 0.1 to about 5.0 phr, or about 0.4 to 3.0 phr, or about 0.5 to about 2.0 phr, or about 0.5 to about 1.5 phr, or 0.1 to 1.2 phr, or 0.1 to 2.7 phr, for example, 2.0 phr, 2.8 phr, 3.6 phr, 5.0 phr, or 7.2 phr. The amount of anti-block agent in any layer of the multilayer film of the disclosure can also be expressed in terms of a percent of the total weight of the layer. A first layer of a multilayer water-soluble film according to the disclosure can comprise an anti-blocking agent in an amount in a range of about 2% to about 10%, or about 3% to about 8%, or about 3.5% to about 6.5%, or about 4% to about 6%, based on the total weight of the first layer. Optionally, a second layer of a film according to the disclosure can be substantially free, or free, of an anti-blocking agent.

A suitable median particle size for the anti-block agent includes a median size in a range of about 3 or about 4 microns to about 11 microns, or about 4 to about 8 microns, or about 5 to about 6 microns, for example 5, 6, 7, or 8 microns. A suitable silica is an untreated synthetic amorphous silica designed for use in aqueous systems.

The multilayer film described herein can have any suitable thickness. For instance, the multilayer film can have a thickness in a range of about 15 microns (μm) to about 150 μm, or about 25 μm to about 100 μm, or about 30 μm to about 70 μm, or about 40 μm to about 60 μm. For example, the water-soluble film can have a thickness of about 40 μm, 45 μm, 50 μm, 51 μm, 60 μm, 76 μm, or 88 μm. The multilayer film can have a thickness in a range of about 25 μm to about 100 μm, or about 40 μm to about 100 μm, or about 30 μm to about 70 μm. Furthermore, each layer of the multilayer film can have any suitable thickness. For example, each layer of the water-soluble film can have a thickness in a range of about 1 micron to about 100 microns, or about 5 μm to about 90 μm, or about 10 μm to about 80 μm, or about 20 μm to about 70 μm, or about 30 μm to about 50 μm, for example about 1 μm, 2 μm, 3 μm, 5 μm, 10 μm, 20 μm, 30 μm, 40 μm, 45 μm, 50 μm, 51 μm, 60 μm, 76 μm, or 88 μm. The first layer can have a thickness in a range of about 1 μm to about 5 μm, The second layer can have a thickness in a range of about 40 μm to about 75 μm. The relative thickness of the layers comprising the multilayer film is not particularly limited. For instance, the ratio of the thicknesses of the first and second layers of a multilayer film of the disclosure can be in a range from about 1:200 to about 200:1, or about 1:100 to 100:1, or about 1:20 to about 20:1, or about 1:5 to about 5:1, or about 1:2 to 2:1, or about 1:1.

A multilayer film produced by a simultaneous solution co-casting process according to the disclosure can include a layer comprising a foamed film, that is, a layer of film that includes a plurality of macroscopic and/or microscopic voids. The top layer of the simultaneously co-cast multilayer film can be a foamed film layer. The simultaneously co-cast multilayer film can be a dual layer film having a top layer comprising a foamed film. A foamed film layer can be produced by casting a layer of a foamed resin solution (that is, a resin solution in which air or another gas has been entrained) and drying the foamed resin solution layer to provide a film layer containing a plurality of macroscopic and/or microscopic voids. A foamed resin solution can be formed by mixing a resin solution sufficiently to entrain air. Alternatively, a foamed resin solution can be formed by in-line mixing during a simultaneous solution co-casting process. For instance, a resin solution can be mixed in an in-line mixing apparatus disposed downstream of a holding tank containing the resin solution and upstream of a casting surface onto which the resin solution layer is cast, such that air or another gas is entrained in the resin solution as the solution is being fed to the casting surface. Optionally, in-line mixing can also include mixing the resin solution with a separate gas feed to entrain gas in the resin solution.

A multilayer film can include a layer comprising a foamed film. The foamed layer can be cast over already-formed film, one made by any process, and this can be referred to as overcasting. The foamed layer can be cast over a just-formed film in the same process, and this can be referred to as sequential casting. The top layer of a multilayer film can be a foamed film layer. The sequentially-cast multilayer film can be a dual layer film having a top layer comprising a foamed film layer, i.e., one in which the foamed film layer is cast over a lower, base layer. A sequential casting process for forming a dual layer film having a layer of foamed film can include casting a layer of a second resin solution onto a casting surface by any suitable means to form a second (bottom) resin solution layer; at least partially drying the second resin solution layer; casting a first (top) resin solution directly onto the at least partially dried second resin solution layer, wherein the first resin solution is a foamed resin solution; and drying the resulting multilayer composition to form a multilayer film. The resin solutions can be cast according to solution casting methods known in the art. The lower, base layer can be a film made by any process, e.g., a cast film or a blown film. The second resin solution can be cast using a die, such as a slot die; and the first resin solution can be cast using any suitable process, for example a doctor blade apparatus, or can be cast.

The top and bottom layers of a bilayer film comprising a top layer that is a foamed film layer can independently comprise a PVOH homopolymer, a PVOH copolymer, or a blend thereof. Optionally, the foamed film layer can comprise an anionic-modified PVOH copolymer. Optionally, the bottom layer can comprise an anionic-modified PVOH copolymer. Optionally, both the foamed film layer and the bottom layer can comprise anionic-modified PVOH copolymers, wherein the foamed film layer and the bottom layer can optionally comprise the same anionic-modified PVOH copolymer.

Casting a layer of a foamed resin solution, i.e., a resin solution in which air or another gas has been entrained, can provide, after drying, a foamed film layer containing macroscopic and/or microscopic voids. A foamed film layer can be characterized by an entrained gas fraction, i.e., a percent increase in volume of the foamed film layer relative to the volume of an otherwise identical film prepared from the same amount of the same resin solution which has not been foamed, i.e., has not been mixed sufficiently to entrain air or another gas. A foamed film layer of a water-soluble film according to the disclosure can have an entrained gas fraction of at least about 5 vol %, or at least about 10 vol %, or at least about 20 vol %, or at least about 30 vol %, based on the volume of the second layer.

A water-soluble film according to the disclosure can include a first layer comprising a methacrylate-modified PVOH copolymer, a plasticizer, an anti-blocking agent, and a surfactant, and a second layer comprising a blend of a maleate-modified PVOH copolymer and a monomethyl maleate-modified PVOH copolymer, wherein the first layer and the second layer are present in a ratio of about 1:200 to about 1:1, or about 1:100 to about 1:3, or about 1:20 to about 1:5, based on the total weight of the water-soluble film. A film according to this aspect can exhibit a haze % of less than about 50, as determined by the Haze Test described herein, and a static coefficient of friction between a first and second portion of an outer surface of the first layer of less than about 2, as determined by the Coefficient of Friction Test described herein.

A water-soluble film according to the disclosure can include a first layer comprising a blend of a monomethyl maleate-modified PVOH copolymer and a PVOH homopolymer, and a second layer comprising a blend of polyvinyl alcohol homopolymers, wherein the first layer and the second layer are present in a ratio of about 1:200 to about 1:1, or about 1:100 to about 1:3, or about 1:20 to about 1:5, respectively, based on the total weight of the water-soluble film. A film according to this aspect can exhibit a moisture vapor transmission rate of less than 25 g H₂O/m²/day, as measured by the Moisture Vapor Transmission Rate test method described herein; and a heat-seal strength of at least 15 N, as measured by the Seal Strength Test described herein.

Further provided herein is a water-soluble unit dose article comprising a packet comprising an outer wall, the outer wall having an exterior surface and an interior surface defining an interior pouch volume, the outer wall comprising a multilayer water-soluble film according to the disclosure herein and optionally a composition contained in the interior pouch volume.

The composition contained in the interior pouch volume can be a fabric or home care ingredient, e.g., one described as above in connection with multiple compartment articles. The water-soluble unit dose article can comprise a non-household care composition. The non-household care composition can be selected from agricultural compositions, aviation compositions, food and nutritive compositions, industrial compositions, livestock compositions, marine compositions, medical compositions, mercantile compositions, military and quasi-military compositions, office compositions, recreational and park compositions, pet compositions, a pool and/or water-treatment composition, and a combination thereof. The non-household care composition can be a pool and/or water-treatment composition.

The water-soluble unit dose article can comprise a household care composition. The household care composition can be selected from light duty liquid detergent compositions, heavy duty liquid detergent compositions, hard surface cleaning compositions, laundry detergent gels, bleaching compositions, laundry additives, fabric enhancer compositions, shampoos, body washes, other personal care compositions, and combinations thereof, optionally a liquid laundry detergent composition.

In another aspect of the disclosure, the household care composition can be selected from the group of laundry and automatic dishwashing compositions, including liquid laundry detergent compositions.

In another aspect of the disclosure, the household care composition can be selected from non-laundry and non-automatic dishwashing compositions, e.g., selected from the group consisting of light duty liquid detergent compositions, heavy duty liquid detergent compositions, hard surface cleaning compositions, bleaching compositions, shampoos, body washes, other personal care compositions, and other compositions which are non-laundry and non-automatic dishwashing compositions, or mixtures of any of the foregoing.

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid detergent composition can be used in a fabric hand wash operation or may be used in an automatic machine fabric wash operation.

In other aspects, the household care composition may be an automatic dish washing detergent composition comprising an ingredient selected from surfactant, builder, sulfonated/carboxylated polymer, silicone suds suppressor, silicate, metal and/or glass care agent, enzyme, bleach, bleach activator, bleach catalyst, source of alkalinity, perfume, dye, solvent, filler and mixtures thereof.

The household care composition can comprise one or more acids used to adjust the pH of a solution to an acidic pH. The household care composition can comprise one or more acids, including but not limited to, glycolic acid, citrates, acetic acids, hydrochloric acid, levulinic acid, gluconic acids, or the like. The household care composition can have a pH of less than or equal to 3. The household care composition can have a pH of less than or equal to 2.5. The household care composition can have a pH of less than or equal to 2. The household care composition can have a pH of less than or equal to 1.5.

The water-soluble unit dose article can comprise a concentration of acid, oxidant, base, or combination thereof in a range of 50 wt % to 100 wt %, or 60 wt % to 100 wt %, or 70 wt % to 100 wt %, or 80 wt % to 100 wt %, or 90 wt % to 100 wt %, based on the total weight of the composition contained in the water-soluble unit dose article. The concentration of acid, oxidant, base, or combination thereof in the non-household care composition of the water-soluble unit dose article is in a range of 50 wt % to 100 wt %, or 60 wt % to 100 wt %, or 70 wt % to 100 wt %, or 80 wt % to 100 wt %, or 90 wt % to 100 wt %, based on the total weight of the non-household care composition.

Optionally, water-soluble unit dose articles of the disclosure can be characterized by a disintegration time of no more than 300 seconds according to MSTM 205 in 23° C. water after exposure to a TCCA, SBS, or calcium hypochlorite composition for 6 or 8 weeks in a 38° C. and 80% RH atmosphere. The disintegration time can be controlled by selection of the film thickness, and the resistance of the film to such harsh chemicals can be mitigated, e.g., by inclusion of an antioxidant.

The surface area of the residue of the water-soluble unit dose article after testing according to MSTM 205 in 23° C. water after exposure to a TCCA, SBS, or calcium hypochlorite composition for 6 or 8 weeks in a 38° C. and 80% RH atmosphere can be less than about 50% of the surface area of the water-soluble unit dose prior to testing according to MSTM 205.

The water-soluble unit dose article can be provided in any dimension suitable to fit through the neck of a trigger spray bottle (e.g., a spray bottle with a screw top neck having about a 28 mm diameter). The water-soluble unit dose article optionally can have a length of about 250 mm or less, or in a range of about 5 mm to about 250 mm, about 10 mm to about 250 mm, about 25 mm to about 250 mm, about 50 mm to about 225 mm, about 100 mm to about 225 mm, about 150 to about 225 mm, about 175 mm to about 225 mm, or about 200 mm. The water-soluble unit dose article optionally can have a width of about 50 mm or less, or in a range of about 2 mm to about 50 mm, about 5 mm to about 45 mm, about 10 mm to about 40 mm, about 15 mm to about 35 mm, or about 20 mm to about 30 mm. The water-soluble unit dose article can have a length of about 175 mm to about 225 mm, or about 200 mm and a width of about 20 mm to about 30 mm, or about 25 mm. In embodiments wherein the water-soluble unit dose article is provided to fit through the neck of a trigger spray bottle, the water-soluble unit dose article optionally comprises a household care composition having a pH of less than or equal to 2.

The water-soluble unit dose article can be heat sealed or solution sealed by any suitable process and apparatus, such as those already well-known in the art. For example, the water-soluble unit dose articles can be heat sealed on three sides. For example, the water-soluble film can be folded over onto itself and sealed on the edge opposite the fold and along one of the two remaining open edges with a heat impulse sealer, to provide a pouch of desired dimensions. A liquid composition (e.g., a household care composition) can be filled into the pouch using an injection system such as a pump or a syringe. Optionally, the water-soluble film can be stretched over a cavity of a specified dimension and heat and a vacuum can be applied to form the film into the shape of the cavity. The cavity can be then filled with the desired composition (e.g., a household care composition). The filled pouch can then be sealed with a second film. The second film can be pulled over the top of the cavity, and the side of the second film facing the filled pouch can be wetted for solution sealing. Pressure can be applied and the filled pouch can be bonded to the second film around the shaped cavity to form an encapsulated composition in a water-soluble unit dose article. The solution sealing can be achieved using a Mespack-Cloud sample machine, or the like.

Further provided herein is a process for dosing a composition of bulk water comprising the steps of contacting with bulk water a water-soluble unit dose article as described herein, thereby dissolving at least a portion of the water-soluble film, and releasing the composition to the bulk water.

In general, the bulk water can be any bulk water which requires a non-household care composition provided therein. For example, the bulk water can be a pool or a spa. In general, the temperature of the bulk water can be any temperature sufficient to dissolve or disintegrate at least a portion of the water-soluble film. The bulk water can have a temperature of at least about 10° C., for example, in a range of about 10° C. to about 100° C., about 10° C. to about 70° C., about 10° C. to about 60° C., about 20° C. to about 50° C., or about 20° C. to about 40° C. In general, the bulk water can be characterized by any pH value. For example, the pH of the bulk water can be in a range of about 4 to about 10, about 5 to about 9, or about 6 to about 7.

Method of Making Films

Processes for producing PVOH films by solution casting are well-known in the art. Typically, PVOH polymers and secondary additives are dissolved in a solvent, typically water, to form a resin solution, and the solution is metered onto a casting surface and allowed to substantially dry, or force-dried with heated air, to form a cast film. The resulting cast film is removed from the casting surface and optionally wound onto a roller. The process can be performed batchwise, and is more efficiently performed in a continuous process.

In the formation of continuous film webs, it is the conventional practice to meter a solution of the resin and secondary components onto a moving casting surface, for example, a continuously moving metal drum or belt, then causing the solvent to be substantially removed from the liquid, whereby a self-supporting cast film is formed, and then stripping the resulting cast film from the casting surface. The solution can optionally be metered or coated onto a carrier film, release liner, or removable backing, whereby after solvent removal, the resulting cast film or coating can be separated from the carrier film, release liner, or removable backing (for example, immediately upon drying or at a later point in time, e.g., prior to use) or remain attached to the carrier film, release liner, or removable backing. A film or coating prepared on a carrier film, release liner, or removable backing can be self-supporting or non-self-supporting. Such carrier films, release liners, and removable backings can be made from various materials as is known in the art, e.g., polyethylene, polyethylene oxides, polyethylene terephthalates, polyolefins, oriented polypropylene, polytetrafluoroethylene, polyvinyl chlorides, and crosslinked polyvinyl alcohols.

In general, the casting surface can be any suitable substrate for producing polymeric films known to one of skill in the art. The substrate can be a casting roller or drum, a casting belt, or a combination thereof. As used herein, the substrate is used for producing a polymer film from one or more polymer resins or polymer resin solutions. The substrate comprises a substrate surface and the substrate surface can be coated with a release coating. The polymer resin solutions can be cast onto a substrate while the substrate is moving, e.g., rotating. The substrate can comprise stainless steel, and optionally can have a stainless steel surface. The substrate can comprise stainless steel that is optionally plated, e.g., chrome plated, nickel plated, zinc plated or a combination thereof.

A multilayer film according to the disclosure herein can be produced using a solvent band casting system. The system can include tanks for mixing and/or storing multiple water-soluble resin solutions, each having optional secondary additives, for use with a band casting machine having at least a first and a second rotating drum about which a casting surface is tensioned to travel with the rotation of the drums. A multi-slot die can be used to simultaneously cast one or more resin solutions from tanks to form a multilayer solution composition on the casting surface. A drying chamber, enclosing at least a portion of the casting surface downline of the die, is used to remove solvent from the multilayer solution composition as it travels in a thin sheet on the casting surface. In addition, a release coating can be applied to the casting surface to provide one or more advantages to the film and/or the process. For example, the release coating can substantially reduce or eliminate bubbles in the produced multilayer film, or the release coating can improve the ease of release of the produced film from the casting surface. A roll coater release coating applicator in communication with a supply of a release coating and a portion of the band can transfer fluid release coating to the casting surface prior to application of the resin solutions to the band. A suitable solvent band casting system and related materials are further described in U.S. Patent Application Publication Nos. 2006/0081176 A1 and 2007/0085234 A1, the disclosures of which are incorporated herein by reference in their entireties.

In general, the release coating can comprise one or more surfactants and an optional carrier, e.g., water. The release coating can comprise one or more surfactants, e.g., selected from a fluorosurfactant, a non-fluorinated anionic surfactant, a non-fluorinated zwitterionic surfactant, salts thereof, or any combination thereof. The anionic or zwitterionic surfactant(s) can be non-fluorinated and comprise a C₆-C₃₀ phosphate ester, a C₆-C₃₀ phosphate diester, a C₆-C₃₀ carboxylate, a C₆-C₃₀ dicarboxylate, a C₆-C₃₀ sulfate, a C₆-C₃₀ disulfate, or salts thereof. The release coating can comprise a non-fluorinated zwitterionic surfactant or a salt thereof. The release coating can comprise a non-fluorinated anionic surfactant or a salt thereof. The non-fluorinated anionic surfactant can comprise a C₆-C₃₀ phosphate ester, or a C₈-C₁₆ phosphate ester, C₆-C₆₀ phosphate diester, C₁₆-C₃₂ phosphate diester, a C₆-C₃₀ carboxylate, a C₆-C₃₀ dicarboxylate, a C₆-C₃₀ sulfate, a C₆-C₃₀ disulfate, or a salt thereof. The non-fluorinated anionic surfactant can comprise a C₆-C₃₀ phosphate ester, or a C₆-C₁₈ phosphate ester, C₆-C₆₀ phosphate diester, C₁₈-C₃₂ phosphate diester, or a salt thereof. The anionic surfactant can include one or more of a C₆-based ammonium fluoroaliphatic phosphate ester; tridecyl alcohol ethoxylate phosphate ester, POE-12; tridecyl alcohol ethoxylate phosphate ester, POE-3; laureth-11 carboxylic acid; crypto-anionic surfactant—laureth-6 carboxylic acid; or sodium lauryl ether sulfate, POE-4.

As used herein, the term “non-fluorinated” refers to a surfactant that has less than wt % fluorine based on the total molecular weight of the compound, or less than 0.001 wt % fluorine based on the total molecular weight of the compound, or less than 0.0001 wt % fluorine based on the total molecular weight of the compound.

The release coating can include a fluorosurfactant, e.g., a perfluoroalkyl-containing compound. The fluorosurfactant can include a solution of ZONYL FSP surfactant (E.I. du Pont de Nemours and Company). A range of from about 0.05% by weight to about 5.0% by weight of surfactant in the release coating is contemplated. The amount of surfactant required to provide adequate wetting can vary depending on the film being coated on the band. Other products may require higher concentrations to improve release properties. Hard surface spreading wetting will be more efficient with higher surfactant concentrations until the surfactant solution reaches the critical micelle concentration (CMC). This concentration represents a threshold beyond which additional surfactant will not produce any further efficiency in spreading wetting. However, increasing the concentration beyond the CMC may improve wetting by the polymer solution and improve the release properties of some film formulations.

The release coating can be applied to the surface of a substrate and optionally subsequently dried prior to casting a polymer resin or polymer resin solution onto the surface coated substrate. The release coating can have a pH of about 1 to about 5 when applied to the surface of the substrate, prior to drying the release coating on the surface of the substrate. When the surfactant comprises a non-fluorinated anionic surfactant, a non-fluorinated zwitterionic surfactant, salts thereof, and a combination thereof, the release coating can have a pH of about 1 to about 8 or a pH of about 1 to about 5 when applied to the surface of the substrate, prior to drying the release coating on the surface of the substrate. For example, the release coating, when applied to the surface of the substrate, can have a pH of about 1, about 1.5, about 2, about 2.5, about 3, about 3.5, about 4, about 5, about 6, about 7, or about 8. The release coating can have a pH of about 1 to about 7, or about 1 to about 6, or about 1 to about 4, or about 1 to about 3, or about 2 to about 7, or about 2 to about 6, or about 2 to about 5, or about 2 to about 4, or about 2 to about 3, or about 3 to about 7, or about 3 to about 5, or about 1.5 to about 3.5, or about 4 to about 7 when applied to the surface of the substrate, prior to drying the release coating on the surface of the substrate.

In general, the release coating can have a surfactant concentration in a range of about wt % to about 100 wt %, based on the total weight of the release coating. The release coating can have a surfactant concentration in a range of about 0.001 wt % to about 20 wt % prior to drying the release coating on the surface of the substrate. For example, the release coating can have a surfactant concentration in a range of about 0.001 wt % to about 10 wt %, or about 0.01 wt % to about 5 wt %, or about 0.01 wt % to about 4 wt %, or about 0.01 wt % to about 3 wt %, or about 0.01 wt % to about 2 wt %, or about 0.05 wt % to about 2 wt %, or about 0.1 wt % to about 2 wt %, or about 0.5 wt % to about 2 wt %, prior to drying the release coating on the surface of the substrate. The release coating can have a surfactant concentration in a range of about 0.01 wt % to about 4.00 wt %, based on the total weight of the release coating prior to drying the release coating on the surface of the substrate. The release coating can have a surfactant concentration in a range of about 0.05 wt % to about 2.00 wt %, based on the total weight of the release coating prior to drying the release coating on the surface of the substrate. The release coating can have a surfactant concentration in a range of about 2.5 wt % to about 100 wt %, based on the total weight of the release coating, after drying the release coating on the surface of the substrate. For example, after drying the release coating on the surface of the substrate, the release coating can have a surfactant concentration in a range of about 3 wt % to about 100 wt %, or about 4 wt % to about 90 wt %, or about 4 wt % to about 80 wt %, or about 4 wt % to about 70 wt %, or about 4 wt % to about 50 wt %, or about 4 wt % to about 30 wt %, or about 4 wt % to about 20 wt %, or about 4.7 wt % to about 100 wt %, or about 5 wt % to about 90 wt %, based on the total weight of the release coating. The release coating can have a surfactant concentration in a range of about 4.7 wt % to about 100 wt %, based on the total weight of the release coating, after drying the release coating on the surface of the substrate. For example, the release coating can include an amount of ZONYL surfactant in a range of about 0.05% by weight to about 5.0% by weight, based on the total weight of the release coating.

In general, the release coating as described herein can have a hydrophilic-lipophilic balance in a range of about 1 to about 30. The release coating can have a hydrophilic-lipophilic balance in a range of about 1 to about 20, or about 1 to about 18, or about 1 to about 17, or about 1 to about 16, or about 1 to about 15, or about 2 to about 17, or about 3 to about 17, or about 4 to about 15, or about 5 to about 12, or about 8 to about 12. The release coating can have a hydrophilic-lipophilic balance in a range of about 1 to about 20. The release coating can have a hydrophilic-lipophilic balance in a range of about 3 to about 17.

In general, the release coating has a thickness of about 0.1 nm to about 100 nm on the surface of the substrate. The release coating can have a thickness of about 0.1 nm to about 80 nm, or about 0.1 nm to about 60 nm, or about 0.1 nm to about 40 nm, or about 0.1 nm to about 40 nm, or about 0.1 nm to about 20 nm, or about 0.1 nm to about 10 nm, or about 1 nm to about 10 nm, or about 1 nm to about 5 nm, on the surface of the substrate. The release coating can have a thickness of about 0.1 nm to about 40 nm on the surface of the substrate. The release coating can have a thickness of about 0.1 nm to about 10 nm on the surface of the substrate.

The amount of water in the metered resin solutions of polyvinyl alcohol, additional resins, and/or secondary components for film casting can optionally be selected such that when the solution is heated to the casting temperature, the solutions have the highest solids level below the viscosity inflection point. Methods of determining the amount of solids at the viscosity inflection point are known in the art. In general, the metered resin solutions can comprise from about 60 to 85% water, or about 60 to 75% water, to provide suitable solutions for casting. The viscosity of each resin solution at 175° F. (about 80° C.) can be, for example, at least about 5,000 cPs, or at least about 6,000 cPs, or at least about 7,000 cPs, or at least about 8,000 cPs, or at least about 9,000 cPs. The viscosity of each resin solution at 175° F. (about 80° C.) can be, for example, no greater than about 15,000 cPs, or no greater than 14,000 cPs, or no greater than about 13,000 cPs, or no greater than about 12,000 cPs, or no greater than about 11,000 cPs.

The resin concentrations of the resin solutions are not particularly limited. The first and second resin solutions can independently have resin concentrations in a range of about 1 wt. % to about 50 wt. %, or about 5 wt. % to about 45 wt. %, or about 10 wt. % to about 40 wt. %, or about 20 wt. % to about 35 wt. %, based on the total weight of the respective resin solution. The first resin solution can have a resin concentration in a range of about 1 wt. % to about 50 wt. %. The second resin solution can have a resin concentration in a range of about 5 wt. % to about 37 wt. %.

The resin solutions can be cast at any suitable temperature such that the film optionally has a temperature in a range of about 50° C. to about 105° C., during drying. Without intending to be bound by theory, it is believed that as the resin solution and film temperature decreases significantly below about 50° C., the amount of time required to dry the film undesirably increases, and the length of the drying chamber needed to fully dry the cast solution undesirably increases. Further, without intending to be bound by theory, it is believed that as the solution and film temperature increases significantly above about 105° C., the solvent may rapidly boil out of the film, resulting in defects in the film surface such as holes or blisters in the finished films and/or facilitate undesirable reactions between adjacent PVOH backbone chain resulting in a film having reduced solubility.

In a continuous or semi-continuous casting process, the moving casting surface can have any desired line speed, e.g., in a range of about 5 m/min to about 50 m/min. The line speed can sometimes affect the properties of the resulting film, for example, physical properties, thickness, residual moisture content and film quality. In general, as the line speed decreases, the thickness of the resulting film will increase and as the line speed increases, the thickness of the resulting film will decrease, assuming the delivery rate of solution remains constant. In general, as the line speed increases the residence time of the film in a fixed-size dryer decreases, thereby requiring an increase in drying temperatures, which may result in drying defects or sticking at high enough temperatures. In contrast, as the line speed decreases, the residence time of the film in the dryer increases.

Method of Making Co-Cast Multilayer Films

To prepare co-cast multilayer films, two or more resin solutions as described herein are simultaneously fed to a multi-slot die under conditions suitable to achieve chatter-free, uniform, multilayer films. The resin solutions can be filtered to remove particulates larger than 25 microns prior to being fed to the die. Initially, a second (e.g., bottom) resin solution is cast through a bottom slot of a multi-slot die to form a second solution layer on a substrate. Prior to drying of the second solution layer, a first (e.g., top) resin solution is cast through a first upper slot of the multi-slot die to form a first solution layer in contact with the second solution layer. The resulting multilayer solution composition can be conveyed on the substrate through one or more ovens which are operated at temperatures sufficient to effect drying of the multilayer solution composition and formation of a multilayer film, optionally a self-supporting multilayer film. The drying temperatures are not particularly limited. For instance, the multilayer solution composition can be dried by being exposed to temperatures in a range of about 70° C. to about 180° C., or about 80° C. to about 160° C., or about 90° C. to about 150° C., or about 100° C. to about 150° C., or about 100° C. to about 140° C. Furthermore, the drying time is not particularly limited. For instance, drying the multilayer solution composition can be carried out for a time in a range of about 1 minute to about 60 minutes, or about 1 minute to about 30 minutes, or about 1 minute to about 20 minutes, or about 5 minutes to about 20 minutes, or about 5 minutes to about 15 minutes, or about 10 minutes to about 15 minutes. After exiting the oven(s), the film can be cooled by conveying the substrate over one or more cooling rolls. The cooling time is not particularly limited; for instance, cooling can be carried out for a time in a range of about 1 second to about 30 minutes, or about 1 second to about 20 minutes, or about 30 seconds to about 10 minutes, or about 1 minute to about 5 minutes. The film can then be pulled under tension to release it from the substrate and conveyed onto a winding roller.

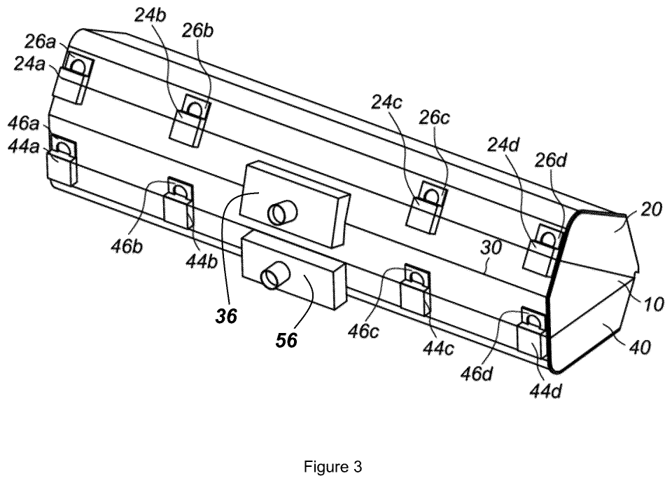

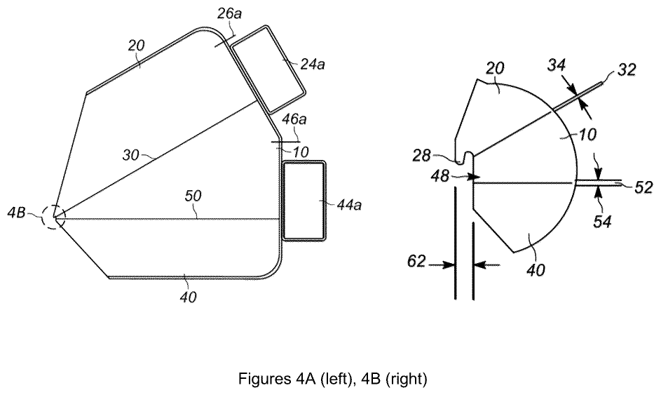

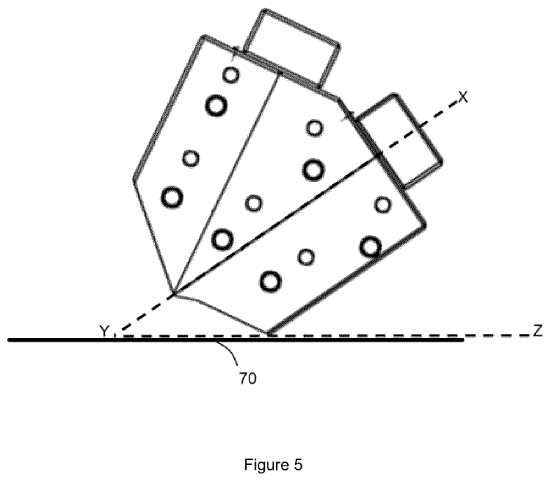

FIG. 3 is a perspective view of a multi-slot die 1 that can be used to prepare co-cast multilayer films of the disclosure. FIG. 4 shows the die 1 of FIG. 3 in side view. The multi-slot die 1 includes a wedge-shaped center die body 10 which separates the upper die body 20 and lower die body 40 so that two feed slots 32 and 52 are formed. Resin solutions are fed to the die through upper injection port 36 and lower injection port 56. Upper offset shims 26a-d and lower offset shims 46a-d are thin sheets of material that are inserted into offset blocks 24a-d and 44a-d, respectively, to control the degree of “overbite” 62, or how far the upper die lip 28 protrudes ahead of the lower die lip 48. These shims are important for controlling the pressure distribution with respect to the machine or down-web direction where the die lips 28 and 48 are disposed adjacent to a casting surface, such as a band. Upper body shim 30 and lower body shim 50 are thin sheets of material that act as spacers between center die body 10 and top die body 20 and lower die body 40, respectively. These shims 30 and 50 set the spacing, or die gap, between the two bodies and thus the heights 34 and 54 of the feed slots 32 and 52 that each solution flows through. Proper die gap settings are important to maintaining the uniformity of flow across the width of each web. Improper die gap settings can result in a film with uneven thickness in the transverse direction. The side view shown in FIG. 4A also indicates upper 26a and lower 46a offset shims and the upper 30 and lower 50 body shims. FIG. 4B, an enlargement of a portion of FIG. 4A, illustrates the level of “overbite” 62 that may be controlled by adjusting the upper offset shims 26a-d and lower offset shims 46a-d. FIG. 5 shows a schematic view of the die 1 in side view with respect to a casting surface 70 to illustrate the die angle LXYZ. The die angle is the angle between the casting surface (indicated by YZ in FIG. 5) and the plane defined by the flow of resin solution through the bottom slot of the die (indicated by XY in FIG. 5).

Process conditions including but not limited to resin solution temperature and viscosity, die head temperature, top and bottom body shim spacings, top and bottom offset shim spacings, die angle, die gaps, line pressures, and line speed may be adjusted as needed to optimize formation of the first and second solution layers and the multilayer solution composition.

Method of Making Sequentially Cast Multilayer Films

Methods for preparing sequentially cast multilayer films are known in the art. In general, a second resin solution can be cast onto a substrate to form a second resin solution layer, the second resin solution can be at least partially dried, and a first resin solution can be cast directly onto the at least partially dried second resin solution layer. The resulting multilayer composition can be conveyed on the substrate through one or more ovens which are operated at temperatures sufficient to effect drying of the multilayer composition and formation of a multilayer film, optionally a self-supporting multilayer film.

The first and second resin solutions can be cast by any suitable means. For example, the second resin solution can be cast using a die, such as a slot die, and the first resin solution layer can be cast using a doctor blade apparatus or other suitable means.

Optionally, the first resin solution in the sequential casting process can be a foamed resin solution, such that the resulting multilayer film comprises a top layer that is a foamed film layer.

### Dissolution, Disintegration, and % Residue Test (MSTM 205)

A film can be characterized by or tested for Dissolution Time and Disintegration Time according to the MonoSol Test Method 205 (MSTM 205), a method known in the art. See, for example, U.S. Pat. No. 7,022,656.

Apparatus and Materials:

600 mL Beaker

Magnetic Stirrer (Labline Model No. 1250 or equivalent)

Magnetic Stirring Rod (5 cm)

Thermometer (0 to 100° C.±1° C.)

Template, Stainless Steel (3.8 cm×3.2 cm)

Timer (0-300 seconds, accurate to the nearest second)

Polaroid 35 mm slide Mount (or equivalent)

MonoSol 35 mm Slide Mount Holder (or equivalent)

Distilled Water

For each film to be tested, three test specimens are cut from a film sample that is a 3.8 cm×3.2 cm specimen. If cut from a film web, specimens should be cut from areas of web evenly spaced along the traverse direction of the web. Each test specimen is then analyzed using the following procedure.

Lock each specimen in a separate 35 mm slide mount.

Fill beaker with 500 mL of distilled water. Measure water temperature with thermometer and, if necessary, heat or cool water to maintain temperature at 20° C. (about 68° F.).

Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the film surface is perpendicular to the flow of the water.

In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

After 300 seconds, if any film residue remained in the frame, the percent of surface area of the film remaining was estimated by visual inspection.

The results should include the following: complete sample identification; individual and average disintegration and dissolution times; and water temperature at which the samples were tested.

Film disintegration times (I) and film dissolution times (S) can be corrected to a standard or reference film thickness using the exponential algorithms shown below in Equation 1 and Equation 2, respectively.

I_{corrected}=I_{measured}×(reference thickness/measured thickness)^{1.93} [1]

S_{corrected}=S_{measured}×(reference thickness/measured thickness)^{1.83} [2]

### Coefficient of Friction Test

The Coefficient of Friction method tests the friction of two pieces of material that are rubbed against each other; the force required to move one piece against the other is measured. The force to start the sled (static friction) and the force to keep the sled moving (dynamic friction) are both measured by the load cell using ASTM D1894 “Friction Testing of Plastic Film and Sheeting.”

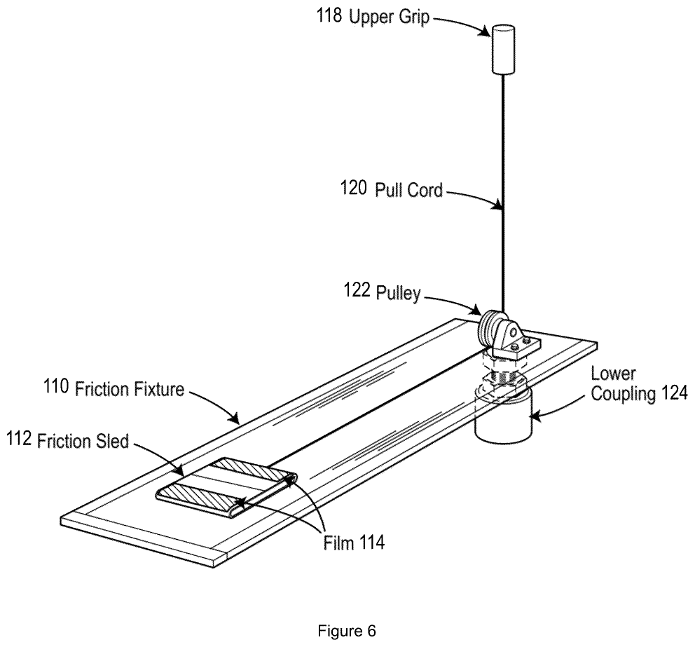

The method uses an Instron® Coefficient of Friction Testing Fixture Model 2810-005, or equivalent, a representative diagram of which is shown in FIG. 6, and an Instron® Testing Machine Model #5543, or equivalent.

The testing apparatus includes a friction fixture 110 upon which rests a friction sled 112 having secured thereon a film sample 114. The sled 112 is coupled to the upper grip 118 via a pull cord 120 which engages with pulley 122 secured to the friction fixture 110. The lower coupling 124 secures the testing fixture to the Instron® testing machine (not shown).

According the Instron® method Blue Hill program: “The system: searches the data from the start value to the end value on the specified channel for the maximum value; determines the first data point that rises and falls by the percentage of the maximum value and assigns this point as the first peak; uses the following equation to determine the coefficient of static friction: static friction=first peak/sled weight; uses the following equation to calculate the average load of the area from the first peak to the end value: average load=energy/change in extension; and uses the following equation to determine the coefficient of dynamic friction: dynamic friction=average load/sled weight.”

The test specimen shall consist of samples having dimensions (5 inch by 5 inch square (12.7 cm by 12.7 cm square) for the sled and 5 inch by 8 inch rectangle (12.7 cm by cm) for the surface, to form a testing area. While it is believed that the film thickness will not affect the Static COF, the film can have a thickness of 3.0±0.10 mil (or 76.2±2.5 μm). The samples can be cut using a razor blade and templates of the appropriate dimensions, for example. When applicable, the sample should be cut with the long dimension parallel to the machine direction of the cast film. Again when applicable, the 5 inch×5 inch sample direction should be noted and oriented in the test so that the direction the sled is being pulled is parallel to the machine direction of the film sample.

The test specimen shall be conditioned at 75° F.±5° F. (about 24° C.±3° C.) and relative humidity 35%±5% for not less than 8 hours prior to the test, and the test is conducted at the same temperature and relative humidity conditions.

Installation Procedure of COF Apparatus
1. Remove the clevis pin from the lower jaw on the Instron® Coefficient of Friction Testing Fixture Model 2810-005, and remove.
2. Remove the clevis pin from the upper jaw, and remove.
3. Place the friction fixture lower coupling onto the base adapter of the Instron® Testing Machine Model #5543.
4. Fit it with the clevis pin.
5. Slip the loop of one end of the pull cord onto the upper clevis pin, and replace the locking clip.
6. Calibrate Testing Machine Model #5543
7. Slip the loop on the other end of the pull cord onto the friction sled hook.
8. Make sure the pulley is able to spin freely
9. Move the sled till the pull cord has no slack and is oriented in the groove around the pulley.
10. Position the moving crosshead (upper heard) of the Instron® Coefficient of Friction Testing Fixture. Model 2810-005 so that there is sufficient travel space to draw the friction sled along the full 50 mm of the test without running the sled into the pulley.
11. Keep the cord taught while the crosshead is moving.
12. Using the JOG control on the Instron #5543 control panel, set the extension limit so that the far end of the friction sled does not exceed the back plane (the plane perpendicular to the axis of motion, and furthest from the pulley) of the friction fixture. Press the GL button to set the travel limit. This prevents the friction sled from colliding with the pulley during the test, and insures that the coefficient of friction of the sample of interest is properly measured.
13. The test fixture is now ready for testing.

Placement of Specimen Procedure
1. Place the surface sample on the aluminum friction fixture in the appropriate orientation.
2. Pull the surface sample tight over the edges of the aluminum surface and tape the sample on the bottom side of the friction fixture.
3. It is important to tape along the end of the friction fixture furthest from the coupling to avoid binding of the sled on the surface.
4. Make sure that the material is taught but not stretched.
5. Wrap the friction sled with the 5×5 inch sample so that the machine direction of the film is parallel to the direction the sled will be pulled.
6. Tape the leading edge overlap on the top of the sled making sure there is no excess material which will bind up on the surface sample.
7. Tape the other edges of the sample on the friction sled to ensure the sample is taught on the contact surface being measured.
8. Be sure that no tape will get between the surface of interest on the sled and on the friction fixture.
9. The samples on the friction surface and on the friction sled should be taught with no wrinkles or bulges; these will cause errors in measuring the COF.
10. Inspect the sled to be sure there are no foreign materials touching the surfaces being tested.
11. Attach the sled to the pull cord and place the sled very lightly and gently on the friction table in order to prevent any unnatural bond from developing between the two specimens, begin test promptly.
12. Be sure that at full extension the sled sits completely over the sample placed on the friction fixture and does not contact tape or hang over the edge of the friction fixture.

Performing the COF Test
1. Test not less than three specimens per requested orientation (example air side-air side or band side-band side).
2. For a combination of air side to band side testing, the air side orientation of the film should be the film sample placed on the aluminum test surface, and the band side for testing should comprise the material wrapped around the sled.
3. Be sure to wear powder-free, moisture barrier gloves while handling the film specimens; powder or moisture may compromise the accuracy of the test.
4. Cut a sample as described above, e.g. using a template.
5. Place the friction sled wrapped in the first specimen at the end of the friction fixture furthest from the pulley.
6. Make sure the pull cord is pulled taught.
7. Open the Coefficient of Friction test titled “COF.im ptf” from the testing screen.
8. Click the start button on the screen to begin the test.
9. Upon completion of the specimen test run, click ok and return the friction sled to the starting position and change the film specimen on the friction sled and the fixture. Repeat the test.

### Moisture Vapor Transmission Rate (MVTR) Test

The multilayer water-soluble film according to the disclosure can be characterized by the amount of moisture transmitted through the film, or layers thereof. The transmission of moisture through a layer or layers can be measured and described by the Moisture Vapor Transmission Rate (MVTR). The MVTR is measured as the daily mass of water transmitted per unit area of the barrier (g H₂O/m²/day).

The MVTR is measured using ASTM F-1249. Prior to testing, the samples are conditioned at 23° C. and 35% RH for at least 8 hours and no more than 48 hours, for example, about 24 hours. Measurements are made at about 38° C. and 50% RH, with the coating layer exposed to the water source.

The multilayer water-soluble film can have a MVTR of about 100 g H₂O/m²/day or less, or about 50 g H₂O/m²/day or less, or about 30 g H₂O/m²/day or less, or about 20 g H₂O/m²/day or less, or about 10 g H₂O/m²/day or less, for example, about 18 g H₂O/m²/day or less, about 16 g H₂O/m²/day or less, about 15 g H₂O/m²/day or less, about 14 g H₂O/m²/day or less, about 12 H₂O/m²/day or less, about 10 g H₂O/m²/day or less, about 8 g H₂O/m²/day or less, about 7 g H₂O/m²/day or less, about 5 g H₂O/m²/day or less, about 3 g H₂O/m²/day or less, about 2.5 g H₂O/m²/day or less, about 1 g H₂O/m²/day or less, or about 0.5 g H₂O/m²/day or less. The water-soluble film can have an MVTR in a range from about 0.05 g H₂O/m²/day to about 20 g H₂O/m²/day, about 0.05 g H₂O/m²/day to about 18 g H₂O/m²/day, about 0.10 g H₂O/m²/day to about 16 g H₂O/m²/day, about 0.15 g H₂O/m²/day to about 14 g H₂O/m²/day, about 0.50 g H₂O/m²/day to about 12 g H₂O/m²/day, about 0.75 g H₂O/m²/day to about 10 g H₂O/m²/day, about 10 g H₂O/m²/day to about 20 g H₂O/m²/day, about 12 g H₂O/m²/day to about 18 g H₂O/m²/day, about 14 g H₂O/m²/day to about 16 g H₂O/m²/day, about 0.05 g H₂O/m²/day to about 10 g H₂O/m²/day, about 1 g H₂O/m²/day to about 8 g H₂O/m²/day, about 2 g H₂O/m²/day to about 6 g H₂O/m²/day, or about 3 g H₂O/m²/day to about 5 g H₂O/m²/day, for example about 0.05, about 0.1, about 0.5, about 1, about 1.5, about 2, about 2.5, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5 about 18, about 18.5, about 19, about 19.5 or about 20 g H₂O/m²/day.

Without intending to be bound by theory, it is believed that the MVTR can be variable with the thickness of the film layer. That is, as the film layer increases in thickness, the MVTR can decrease, and as the film layer decreases in thickness, the MVTR can increase.

### Haze Test

Haze was measured according to ASTM D1003 using a BYK Haze-Gard I Benchtop Haze Meter. Prior to testing, test items were conditioned at 23° C. and 35% RH for at least 8 hours and no more than 48 hours, for example, about 24 hours. Measurements were performed at 23° C. and 35% RH.

### Seal Strength Test

The Seal Strength Test measures the strength of the seal between two sealed film surfaces. The sealed film surfaces can be the surfaces of two different films sealed to each other, or the surfaces of two films having the same composition, or the sealed film surfaces can be surfaces of a single film sealed to itself.

An INSTRON tensile testing apparatus (Model 5544 Tensile Tester or equivalent) is used for the collection of film data. Films can be sealed to each other by any suitable means, including heat-sealing or water-sealing methods known in the art. For example, an ESIPROOF proofing apparatus or equivalent with an anilox roller 140/10 can be used for sealing two sheets of film with water. Alternatively, two sheets of film can be heat-sealed. The seal strength of the seal between two sealed film surfaces can accordingly be characterized as a water seal strength or a heat seal strength. A minimum of three test specimens, each cut with reliable cutting tools to ensure dimensional stability and reproducibility, are tested in the machine direction (MD) (where applicable) for each measurement. Tests conducted in the standard laboratory atmosphere of 23±2.0° C. and 35±5% relative humidity.

Samples for measuring water seal strength can be prepared as follows. Prepare the test specimens by cutting four 100 mm×300 mm film sheets with the 300 mm dimension in the machine direction (MD). For two sheets, tape the four corners of one sheet to a surface. Overlay the other sheet on top of the taped sheet so the appropriate surfaces are in contact. On top of the other taped sheet, place the remaining sheet on top so that the two surfaces to be sealed are contacted with each other. Tape one 100 mm end of each top sheet to secure to the bottom sheet. Thread the loose end of each top sheet through the ESIPROOF proofing roller using the 140/10 anilox roller. Apply 0.5 mL of water to the doctor blade. Pull the roller at a constant speed (75 mm per second) to coat the upper film and secure to the lower sheet. Allow the film to weld for 10-15 minutes. Using a strip punch or sample cutter, cut 25.4 mm wide samples in the transverse direction (TD).

The water-sealed or heat-sealed sample is transferred to the INSTRON testing machine to proceed with testing while minimizing exposure to environment. For the seal strength test, there is a 0.50″ (1.27 cm) separation between the rubber grips, all four of which are flat and square. Three (or more) 1″-wide (2.54 cm) samples are cut in the machine direction (MD). Place the unsealed flaps of a specimen in the grips of the testing machine, taking care to ensure the specimen is aligned with the grips and parallel to them, and that the specimen is not pulled too tightly in the tester's jaws. The load is balanced and the test is initiated according to the instructions of the equipment manufacturer. At the end of the test, the tensile force (in N) required to tear or separate the layers is recorded as the seal strength.

### EXAMPLES

The following examples are provided for illustration and are not intended to limit the scope of the invention.

To prepare co-cast bilayer films, two resin solutions were simultaneously fed through supply lines maintained at 160° F. to 180° F. (about 70° C. to 80° C.) to a multi-slot die under conditions suitable to achieve chatter-free, uniform, multilayer films. Processing conditions were selected to achieve 13 inch to 16 inch (33 cm to 40 cm) wide, 45 to 80 μm thick multilayer films. Co-cast multilayer films were conveyed from the die exit on a stainless steel belt through a 100-foot (30 m) heating tunnel at 4 feet to 13 feet per minute (fpm) (2 cm/s to 6.6 cm/s), peeled off the belt under tension, and wound on a roll.

Resin solutions for preparing cast films, sequentially cast bilayer films, or co-cast bilayer films were prepared according to formulations as described in the Examples below. Resin content of the solutions was generally between 12 to 37 wt. %, though films may be cast from solutions with resin content as low as about 5.0 wt. %. Solutions were mixed with a ribbon blender at 175° F. to 185° F. (about 80° C. to 85° C.) overnight prior to casting to ensure complete dissolution of the resins.

### Example 1: Co-Cast Bilayer Film with High Bio-Based Content

A bilayer film comprising a PVOH-based film layer and a film layer with high bio-based content was prepared according to the co-cast multilayer film preparation procedure described above. Compositions of the dried top and bottom film layers are shown in Table 1. The top layer comprised hydroxypropyl methylcellulose (HPMC; METOLOSE®, Shin-Etsu Chemical Co., Tokyo, Japan) and auxiliary components, including plasticizer and a defoaming agent. Resin solutions for the bottom (PVOH) and top (HPMC) layers were prepared according to the stoichiometries listed in Table 1 and diluted to 24.0 wt. % PVOH and 12.0 wt. % HPMC, respectively. The PVOH and HPMC resin solutions were maintained at about 75° F. and 145° F. (about 24° C. and 63° C.), respectively, and the die head was maintained at about 180° F. (about 80° C.) during co-casting. Line speeds during co-casting ranged from 3 to 6 fpm (about 1.5 to 3 cm/s).

TABLE 1

| | | Weight % |
|---|---|---|
| | Component | of layer |
| Top layer | Hydroxypropyl methylcellulose (HPMC) | 59.0 |
| | Auxiliary components + water | 41.0 |
| Bottom layer | Acrylate-modified PVOH | 60.1 |
| | Plasticizers | 25.9 |
| | Fumed silica | 2.2 |
| | Surfactants | 3.4 |
| | Defoamer | 0.4 |
| | Auxiliary components | 2.0 |
| | Water | 6.0 |

Surprisingly, it was found that the bilayer film of Example 1 could be shaped into a pouch by thermoforming. Films comprising HPMC or other celluloses as the primary or only film-forming resin are typically too brittle to be successfully thermoformed. The simultaneous solution co-casting procedure according to the disclosure can thus provide a film with high bio-based content that embodies advantageous physical properties, such as thermoformability, which are not typically obtainable for bio-based films.

### Example 2: Bilayer Film with Low Haze and Low COF

Single-layer PVOH films 2A-2C containing varying amounts of silica, an anti-blocking agent, were prepared according to the formulations listed in Table 2 using a standard solution casting process. Increasing the amount of silica in a film is expected to reduce the coefficient of friction (COF) between the film and other surfaces but also reduce transparency, i.e., increase the degree of haze. Bilayer film 2D was prepared by sequentially casting a bottom layer of the Film 2B composition (silica-free) and a top layer of the Film 2C composition (high silica), with the bottom layer being allowed to dry before casting the top layer. Haze % and gloss-to-gloss coefficient of friction of each single-layer film and the bilayer film were evaluated by the test methods described herein; these results are also included in Table 2.

Compared to Film 2A, Film 2B exhibited lower haze but higher COF, as expected due to the absence of silica, and Film 2C exhibited lower COF but higher haze, as expected due to the high silica loading. The bilayer film 2D, however, exhibited low COF, comparable to that of the 2× silica film, and haze comparable to that of the control film 2A with roughly the same total silica loading. The bilayer film thus exhibited advantageous properties of both layers, a combination which was previously possibly only in individual films with countervailing disadvantages.

TABLE 2

| | Film: | | | |
|---|---|---|---|---|
| | 2A | 2B | 2C | 2D |
| | Description: | | | |
| | Single | Single | Single | |
| | Layer | Layer | Layer | Bilayer |
| | (1x silica) | (no silica) | (2x silica) | (2B + 2C) |
| Component (wt %) | | | | |
| PVOH | 61.0% | 62.8% | 59.9% | |
| (Monomethyl maleate | | | | |
| modified, 1.7 mol %) | | | | |
| Plasticizers | 26.3% | 27.1% | 25.8% | |
| (Glycerin + sorbitol + | | | | |
| trimethylolpropane) | | | | |
| Silica | 2.2% | | 4.5% | |
| Surfactants | 3.4% | 3.5% | 3.4% | |
| Auxiliary components | 1.0% | 0.6% | 0.6% | |
| Water | 6.0% | 6.0% | 6.0% | |

Properties

| | | | | |
|---|---|---|---|---|
| G—G COF | 2.5 | 4.8 | 1.1 | 1.1 |
| Haze (%) | 48 | 40 | 63 | 50 |

### Example 3: Co-Cast Bilayer Film with Low Haze and Low COF

Single-layer PVOH films 3A and 3B were prepared according to the formulations listed in Table 3 using a standard solution casting process. Bilayer film 3C, comprising a top layer of the 3A composition and a bottom layer of the 3B composition, was prepared by a simultaneous solution co-casting process. For preparing the bilayer film, aqueous resin solutions were prepared having stoichiometries corresponding to those of the 3A and 3B compositions but diluted to PVOH concentrations of 31.5 wt % and 28.7 wt %, respectively. The resin solutions were fed simultaneously to a multi-slot die and co-cast onto a continuously moving metal band, with the 3B solution fed through the bottom die slot and the 3A solution fed through the top die slot. Resin solutions were maintained at 180° F. (about 80° C.) during casting and were filtered through a medium to reject particles larger than 25 μm as the solutions were fed to the multi-slot die. Body shim spacings were 0.01 inch (0.254 mm) for the top and bottom slots. The top offset shim spacing was 0.005 inch (0.127 mm) and the bottom offset shim spacing was 0.01 inch (0.254 mm). During casting, the die angle was adjusted between 48.5°-50.1° and the die-belt gap was adjusted between 0.025 inch and 0.040 inch (0.635 mm and 1.016 mm). Line speed ranged from 6 to 10 fpm (about 3 to 5 cm/s). Top and bottom die slots were maintained during casting between about 140° F. to 180° F. (about 60° C. to 80° C.). The co-cast bilayer film was conveyed from the die exit through a heating tunnel with heating zones maintained at about 310° F. and about 230° F. (about 155° C. and 110° C.) to dry the co-cast film.

TABLE 3

| | Film: | | |
|---|---|---|---|
| | 3A | 3B | 3C |
| | Description: | | |
| | | | Co-cast Bilayer |
| | | | Top layer: 3A |
| | Single Layer | Single Layer | Bottom layer: 3B |
| Component (wt %) | | | |
| PVOH | 60.1% | | |
| (Acrylate-modified) | | | |
| PVOH | | 74.9% | |
| (Monomethyl maleate- | | | |
| modified) | | | |
| Sodium hydroxide | 1.8% | | |
| Glycerin | 14.8% | 11.5% | |
| Sorbitol | 7.9% | 4.8% | |
| Trimethylolpropane | 3.2% | | |
| Silica | 2.2% | | |
| Starch | 2.1% | 2.0% | |
| Surfactants | 1.4% | 0.3% | |
| Auxiliary components | 0.6% | 0.4% | |
| Water | 6.0% | 6.0% | |

Properties

| | | | |
|---|---|---|---|
| G—G COF | 0.9 | 21.2 | 0.9 |
| Haze (%) | 57 | 35 | 41 |

Table 3 shows that the simultaneously co-cast bilayer film exhibited favorable attributes of both component layers, namely low coefficient of friction and low haze, without offsetting disadvantages.

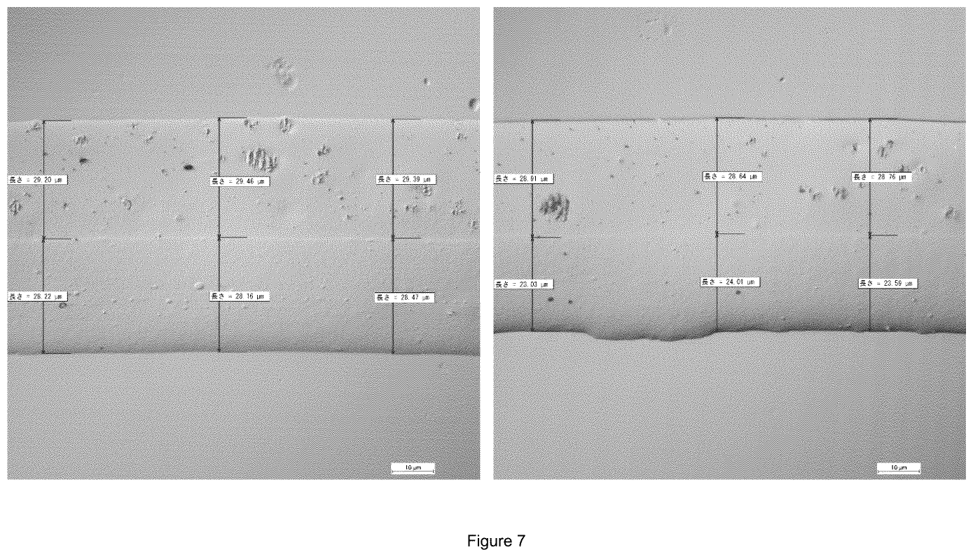

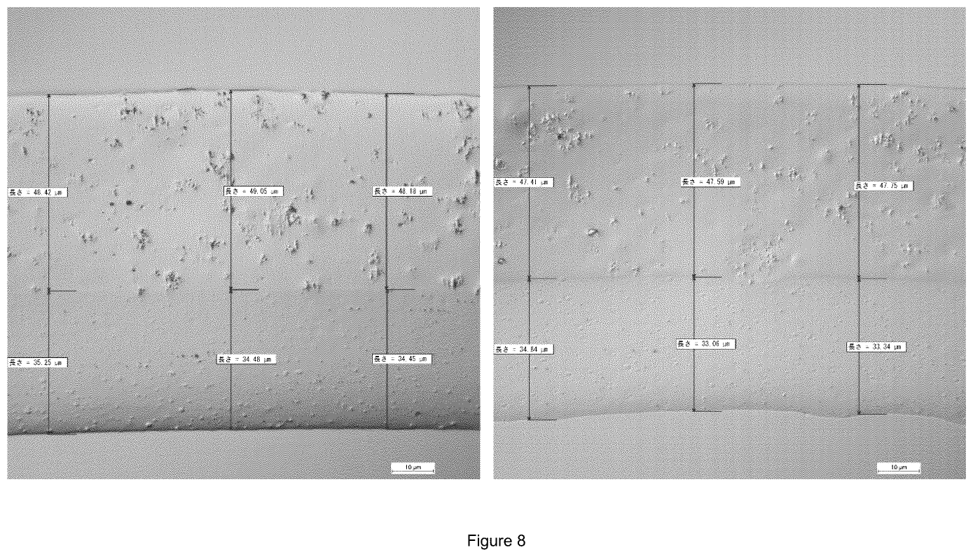

FIG. 7 shows optical microscopy images of cross sections of co-cast bilayer film 3C obtained by cutting the film along the machine direction (MD, shown in left image) or along the transverse direction (TD, shown in right image), respectively. The images in FIG. 6 are shown in the same orientation in which the films were cast; that is, the bottom film layer in each image is the layer of the co-cast film that was in direct contact with the casting band. FIG. 7 indicates that the component layers of the co-cast film were highly integrated and that minimal mixing of the layers occurred during the simultaneous solution co-casting process. Shown for comparison in FIG. 8 are cross-sectional images of a bilayer film having the same bottom and top layer compositions as film 3C which was prepared by a sequential casting process, in which the bottom layer was cast from solution and dried and the top layer was cast from solution onto the dried bottom layer film. As in FIG. 7, the left and right images show cross sections taken in the MD and TD, respectively.

A bilayer film similar in composition to bilayer film 3C was prepared by a simultaneous solution co-casting process to demonstrate that very thin film layers are accessible by the disclosed co-casting process. Bilayer film 3F was prepared by a simultaneously co-casting a bottom layer of composition 3D and a top layer of composition 3E, as shown in Table 4. As with film 3C, the top layer of film 3F contains silica and the bottom layer contains no silica. The flow rates of the resin solutions through the multi-slot die were separately controlled to provide dry film thicknesses of 70 microns and 1 micron for the bottom and top film layers, respectively. Table 4 includes coefficient of friction and haze data for the bilayer film and for single-layer films with the compositions of the top and bottom layers of the bilayer film. Despite having a very thin top silica-containing layer, film 3F embodies the advantageous combination of low coefficient of friction and low haze. The results shown in Table 4 demonstrate that very thin top film layers are accessible by simultaneous co-casting.

TABLE 4

| | Film: | | |
|---|---|---|---|
| | 3D | 3E | 3F |
| | Description: | | |
| | | | Co-cast Bilayer |
| | | | Top layer: 3D |
| | Single Layer | Single Layer | Bottom layer: 3E |
| Component (wt %) | | | |
| PVOH | 60.1% | | |
| (Acrylate-modified) | | | |
| PVOH | | 74.9% | |
| (Monomethyl maleate- | | | |
| modified) | | | |
| Sodium hydroxide | 1.8% | | |
| Glycerin | 16.9% | 11.5% | |
| Sorbitol | 9.0% | 4.8% | |
| Silica | 2.2% | | |
| Starch | 2.1% | 2.0% | |
| Surfactants | 1.4% | 0.3% | |
| Auxiliary components | 0.6% | 0.4% | |
| Water | 6.0% | 6.0% | |

Properties

| | | | |
|---|---|---|---|
| G—G COF | 0.9 | 21.2 | 0.9 |
| Haze (%) | 57 | 35 | 43 |

### Example 4: Bilayer Film with High Moisture Barrier and High Seal Strength

Bilayer film 4C, comprising a top layer of the 4A composition and a bottom layer of the 4B composition listed in Table 5, was prepared by a simultaneous solution co-casting process. For preparing the bilayer film, aqueous resin solutions were prepared having stoichiometries corresponding to those of dry film formulations 4A and 4B, diluted to PVOH concentrations of 30.7 wt % and 36.6 wt %, respectively, for casting. The resin solutions were fed simultaneously to a multi-slot die and co-cast onto a continuously moving metal band, with the 4B solution fed through the bottom die slot and the 4A solution fed through the top die slot. Resin solutions were maintained at 180° F. (about 80° C.) during casting and were filtered through a medium to reject particles larger than 25 μm as the solutions were fed to the multi-slot die. Body shim spacings were 0.015″ for the top and bottom slots. The top offset shim spacing was 0.002 inch (0.05 mm) and the bottom offset shim spacing was 0.01 inch (0.254 mm). During casting, the die angle was adjusted between 48° to 60° and the die-belt gap was set at 0.025 inch (0.635 mm). Line speed ranged from 2 to 6 fpm (about 1-3 cm/s). Top and bottom die slots were maintained during casting between about 140° F. to 180° F. (about 60° C. to 80° C.). The co-cast bilayer film was conveyed from the die exit through a heating tunnel with heating zones maintained at about 310° F. and about 230° F. (about 155° C. and 110° C.) to dry the co-cast film. Bilayer film 4C had a heat-seal strength of 13.7 N.

TABLE 5

Film:

| | |
|---|---|
| 4A | 4B |

Description:

| | Top layer of | Bottom layer of |
|---|---|---|
| | bilayer film 4C | bilayer film 4C |
| Component (wt %) | | |
| PVOH (homopolymer) | 39.3% | 66.6% |
| PVOH (monomethyl | 26.2% | |
| maleate-modified) | | |
| Glycerin | 12.5% | 12.9% |
| Sorbitol | 6.8% | 5.5% |
| Trimethylolpropane | 2.8% | |
| Dipropylene glycol | | 3.7% |
| Silica | 1.8% | 1.8% |
| Starch | 1.9% | 1.0% |
| Surfactants | 2.0% | 1.9% |
| Auxiliary components | 0.7% | 0.6% |
| Water | 6.0% | 6.0% |

### Example 5: Bilayer Film with High Moisture Barrier and High Seal Strength

Single-layer PVOH films with dry film compositions 5A and 5B in Table 6 were prepared using a standard solution casting process. Sequentially-cast bilayer film 5C comprises a layer of 78 μm bottom layer of the 5B composition and an 11 μm top layer of the 5A composition. As seen in Table 6, film 5A exhibits high heat seal strength but also exhibits high moisture vapor transmission, while film 5B provides a high barrier to moisture vapor transmission but exhibits poor seal strength. Bilayer film 5C, however, exhibits the advantageous properties of both component films: a heat seal strength nearly as high as that of the single-layer film 5A and a moisture vapor transmission rate nearly as low as that of the single-layer film 5B, without countervailing disadvantages.

TABLE 6

| | Film: | | |
|---|---|---|---|
| | 5A | 5B | 5C |
| | Description: | | |
| | | | Bilayer |
| | | | Top layer: 5A |
| | Single layer | Single layer | Bottom layer: 5B |
| Component (wt %) | | | |
| PVOH (homopolymer) | 55.8 | 71.5 | |
| Polysorbate 80 | 0.8 | 1.0 | |
| Sodium carboxymethyl | 9.5 | 12.2 | |
| cellulose | | | |
| Glycerin | 8.5 | | |
| Polypropylene glycol | 12.1 | | |
| Sorbitol | 2.6 | 3.3 | |
| Xylitol | 4.8 | 6.1 | |
| Water | 6.0 | 6.0 | |

Properties

| | | | |
|---|---|---|---|
| Heat Seal Strength (N) | 20.9 | 0.23 | 18.1 |
| MVTR (g/m² per 24 hr) | 205 | 17.5 | 22.5 |

### Example 6: Sequentially-Cast Bilayer Film Having a Foamed Film Layer

A bilayer film comprising a foamed film layer as a first (i.e., top) layer was prepared by a sequential casting process. A second resin solution comprising water, 36 wt. % of an anionic-modified PVOH resin, plasticizer, other additives, and a defoamer was prepared by mixing using a ribbon blender. A first resin solution comprising water, 36 wt. % of the anionic-modified PVOH resin, plasticizer, other additives, and no defoamer was prepared by mixing using a ribbon blender. Mixing the first resin solution provided a foamed resin solution having a volume about 30% greater than that of the resin solution before mixing. Mixing the second resin solution did not markedly increase its volume. The increase in volume of the first resin solution was attributed to entrainment of air via foam formation. The foamed first resin solution was stable; however, pumping of the foamed resin solution was more difficult than pumping of second (i.e., not foamed) resin solution.

The lower, in this case bottom, film layer of the bilayer film was produced by casting the second resin solution through the bottom slot of a die onto a substrate and partially drying the bottom film layer by applying heat. The top film layer of the bilayer film was produced by casting the (foamed) first resin solution directly onto the partially dried bottom film layer using a doctor blade apparatus, and the resulting multilayer composition was dried to provide a bilayer film.

The bilayer film was stable, in that the bottom (non-foamed) and top (foamed) layers did not readily delaminate from each other.

### Example 7: Simultaneously Co-Cast Bilayer Film Having a Foamed Film Layer

The first and second resin solutions described in Example 6 were prepared, and the first resin solution was mixed using a ribbon blender as described in Example 6 to form a foamed resin solution. The second and (foamed) first resin solutions were then simultaneously fed to a multi-slot die. The second resin solution was fed through the lower die slot and the (foamed) first resin solution was fed through the upper die slot, such that the second resin solution was cast on a continuously moving substrate (the rate of travel being referred to as a “line speed”) and the first resin solution was cast directly onto the second resin solution to form a bilayer solution composition. Die heads were maintained at 75-85° C. (167-185° F.) during co-casting. The resulting bilayer solution composition was subsequently passed through ovens to dry the film and form the bilayer film.

Some parameters, such as line speed, were varied during simultaneous co-casting to try to achieve optimal casting conditions. Under some casting conditions, the top resin solution layer did not appear to be fully stable. In particular, as the line speed was increased, the top resin solution layer appeared to de-wet from the bottom resin solution layer. Thus, the line speed can be controlled to provide a stable multilayer film structure, i.e., by reducing the speed as necessary. Furthermore, as noted in Example 6, the foamed resin solution was more difficult to pump from its holding tank to the casting apparatus than a non-foamed resin solution. Thus, higher pumping pressure can be used for the foamed resin solution, relative to the pressure for the non-foamed resin solution. In-line mixing of the top resin solution to form the foamed resin solution is contemplated to provide more consistent casting results.

The foregoing description is given for clearness of understanding only, and no unnecessary limitations should be understood therefrom, as modifications within the scope of the invention may be apparent to those having ordinary skill in the art.

All patents, publications and references cited herein are hereby fully incorporated by reference. In case of conflict between the present disclosure and incorporated patents, publications and references, the present disclosure should control.

1.-55. (canceled)

56. A process for preparing a multilayer water-soluble film, comprising:
(a) simultaneously casting at least a first water-soluble resin solution comprising a first water-soluble resin and a second water-soluble resin solution comprising a second water-soluble resin onto a surface of a substrate, wherein the second water-soluble resin solution is cast in contact with the substrate and the first water-soluble resin solution is cast in contact with the second water-soluble resin solution to form a multilayer structure comprising a second solution layer comprising the second water-soluble resin in contact with the substrate and a first solution layer comprising the first water-soluble resin in contact with the second solution layer;
(b) drying the multilayer structure to form a multilayer water-soluble film comprising at least a first layer and a second layer; and
(c) optionally releasing the multilayer water-soluble film from the surface of the substrate.

57.-74. (canceled)

75. The process of claim 56, wherein simultaneously casting at least a first water-soluble resin solution and a second water-soluble resin solution comprises simultaneously passing the first water-soluble resin solution through a first slot of a multi-slot die and passing the second water-soluble resin solution through a second slot of the multi-slot die, and
wherein the angle between a plane defined by the substrate and a plane defined by the flow of the second water-soluble resin solution through the second slot of the multi-slot die is in a range of about 40° to about 90°.

76. (canceled)

77. (canceled)

78. (canceled)

79. A water-soluble film comprising a first layer and a second layer in contact with one another,
wherein the first layer comprises a first water-soluble resin comprising a methacrylate modified polyvinyl alcohol copolymer, and the second layer comprises a second water-soluble resin comprising a blend of a maleate-modified polyvinyl alcohol copolymer and a monomethyl maleate-modified polyvinyl alcohol copolymer;
wherein the first layer and the second layer are present in a ratio of about 1:200 to about 1:1, respectively, based on the total weight of the water-soluble film;
wherein the first layer includes a first surface forming an outer surface of the film;
wherein the film exhibits a haze % of less than about 50, as determined by the Haze Test;
wherein the static coefficient of friction between a first portion of the outer surface of the film and a second portion of the outer surface of the film is less than about 2, as determined by the Coefficient of Friction Test; and
wherein the first layer comprises a plasticizer, an anti-blocking agent, and a surfactant, and the second layer comprises a plasticizer and a surfactant.

80. A water-soluble film comprising a first layer and a second layer in contact with one another,
wherein the first layer comprises a first water-soluble resin comprising a blend of a monomethyl maleate-modified polyvinyl alcohol copolymer and a polyvinyl alcohol homopolymer, and the second layer comprises a blend of polyvinyl alcohol homopolymers;
wherein the first layer and the second layer are present in a ratio of about 1:200 to about 1:1, respectively, based on the total weight of the water-soluble film;
wherein the film exhibits a MVTR of less than 25 g H₂O/m²/day, as measured by the Moisture Vapor Transmission Rate test; and
wherein the film exhibits a heat-seal strength of at least 15 N, as measured by the Seal Strength Test.

81. A water-soluble film comprising a first layer and a second layer in contact with one another,
wherein the first layer comprises a first water-soluble resin comprising (a) a polyvinyl alcohol homopolymer, a polyvinyl alcohol copolymer, or a mixture thereof and (b) hydroxypropyl methylcellulose, and the second layer comprises a polyvinyl alcohol copolymer; and
wherein the first layer and the second layer are present in a ratio of about 1:200 to about 1:1, respectively, based on the total weight of the water-soluble film.

82. (canceled)

83. A multilayer water-soluble film comprising a first layer and a second layer in contact with each other,
wherein the first layer comprises a first water-soluble resin comprising a polyvinyl alcohol homopolymer, a polyvinyl alcohol copolymer, or a blend thereof, and the second layer comprises a second water-soluble resin comprising a polyvinyl alcohol homopolymer, a polyvinyl alcohol copolymer, or a blend thereof; and
wherein the first layer comprises a foamed film layer having an entrained gas fraction of at least about 5 vol %, based on the volume of the first layer.

84. (canceled)

85. A multilayer water-soluble film comprising a first layer and a second layer in continuous contact with one another,
wherein the first layer comprises a first water-soluble resin comprising a polyvinyl alcohol homopolymer, a polyvinyl alcohol copolymer, a bio-based resin, or a blend thereof, and the second layer comprises a second water-soluble resin comprising a polyvinyl alcohol homopolymer, a polyvinyl alcohol copolymer, or a blend thereof;
wherein the first layer has a first heat history and the second layer has a second heat history; and
the first heat history is the same as the second heat history.

86. The water-soluble film of claim 85, wherein the first heat history and second heat history comprise the drying times and drying temperatures to which the first layer and second layers are subjected.

87. The water-soluble film of claim 85,
wherein the second layer comprises an outer surface; and
wherein the film, when sealed to itself by a first portion of the second layer outer surface being sealed to a second portion of the second layer outer surface, has a water seal strength of about 10 N or more based on the Seal Strength Test, and a moisture vapor transmission rate of about 100 g/m² or less per 24 hours, based on the Moisture Vapor Transmission Rate test method.

88. The water-soluble film of claim 85,
wherein the first layer comprises an anti-blocking agent, and the amount of anti-blocking agent in the first layer, as a percentage of the total weight of the first layer, is higher than the amount of anti-blocking agent in the second layer, as a percentage of the total weight of the second layer;
wherein the first layer has a first surface forming an outer surface of the film;
wherein the film has a static coefficient of friction (static COF) between a first portion of the outer surface of the film and a second portion of the outer surface of the film, as determined by the Coefficient of Friction Test;
wherein the film has a haze (%), as determined by the Haze Test; and
wherein the combination of haze (%) and static coefficient of friction lies within a polygon defined by the vertices (haze (%), static COF) of about (0.03, 13), about (59, 0.5), about (10, 0.1) and about (0.1, 0.1), or within a polygon defined by the vertices (haze (%), static COF) of about (0.03, 10), about (55, 0.5), about (10, 0.1) and about (0.1, 0.1).

89. The water-soluble film of claim 88, wherein the first layer comprises the anti-blocking agent in an amount in a range of about 2% to about 10% by weight of the first layer.

90. The water-soluble film of claim 88, wherein the second layer is substantially free of anti-blocking agent.

91. The water-soluble film of claim 85, wherein the first water-soluble resin comprises a polyvinyl alcohol copolymer.

92. The water-soluble film of claim 85, wherein the second water-soluble resin comprises a polyvinyl alcohol copolymer.

93. The water-soluble film of claim 91, wherein the first water-soluble resin comprises a blend of a polyvinyl alcohol homopolymer and a polyvinyl alcohol copolymer.

94. The water-soluble film of claim 91, wherein the polyvinyl alcohol copolymer comprising the first water-soluble resin comprises an anionic-modified polyvinyl alcohol.

95. The water-soluble film of claim 92, wherein the second water-soluble resin comprises a blend of a polyvinyl alcohol homopolymer and a polyvinyl alcohol copolymer.

96. The water-soluble film of claim 92, wherein the polyvinyl alcohol copolymer comprising the second water-soluble resin comprises an anionic-modified polyvinyl alcohol.

97. The water-soluble film of claim 94, wherein the anionic-modified polyvinyl alcohol comprising the first water-soluble resin comprises an anionic monomer unit derived from a monomer selected from the group of vinyl acetic acid, alkyl acrylates, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, fumaric anhydride, itaconic acid, monomethyl itaconate, dimethyl itaconate, itaconic anhydride, citraconic acid, monoalkyl citraconate, dialkyl citraconate, citraconic anhydride, mesaconic acid, monoalkyl mesaconate, dialkyl mesaconate, mesaconic anhydride, glutaconic acid, monoalkyl glutaconate, dialkyl glutaconate, glutaconic anhydride, vinyl sulfonic acid, alkyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid, 2-sulfoethyl acrylate, alkali metal salts thereof, esters thereof, and combinations thereof.

98. The water-soluble film of claim 97, wherein the anionic monomer unit is derived from a monomer selected from the group of maleic acid, monoalkyl maleate, dialkyl maleate, maleic anhydride, alkali metal salts thereof, esters thereof, and combinations thereof.

99. The water-soluble film of claim 96, wherein the anionic-modified polyvinyl alcohol comprising the second water-soluble resin comprises an anionic monomer unit derived from a monomer selected from the group of vinyl acetic acid, alkyl acrylates, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, fumaric anhydride, itaconic acid, monomethyl itaconate, dimethyl itaconate, itaconic anhydride, citraconic acid, monoalkyl citraconate, dialkyl citraconate, citraconic anhydride, mesaconic acid, monoalkyl mesaconate, dialkyl mesaconate, mesaconic anhydride, glutaconic acid, monoalkyl glutaconate, dialkyl glutaconate, glutaconic anhydride, vinyl sulfonic acid, alkyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid, 2-sulfoethyl acrylate, alkali metal salts thereof, esters thereof, and combinations thereof.

100. The water-soluble film of claim 99, wherein the anionic monomer unit is derived from a monomer selected from the group of maleic acid, monoalkyl maleate, dialkyl maleate, maleic anhydride, alkali metal salts thereof, esters thereof, and combinations thereof.

101. The water-soluble film of claim 85, wherein the first water-soluble resin comprises a bio-based resin and the bio-based resin comprises a cellulosic polymer.

102. The water-soluble film of claim 101, wherein the cellulosic polymer comprises hydroxypropyl methylcellulose.

103. The water-soluble film of claim 85, wherein the first layer and/or the second layer further comprises a plasticizer.

104. The water-soluble film of claim 103, wherein the plasticizer comprising the first layer and/or the plasticizer comprising the second layer are independently selected from the group of glycerol, trimethylolpropane, sorbitol, propylene glycol, dipropylene glycol, polypropylene glycol, diglycerol, 2-methyl-1,3-propanediol, and combinations thereof.

105. The water-soluble film of claim 85, wherein the thickness of the film is in a range of about 40 microns to about 100 microns.

106. The water-soluble film of claim 105, wherein the thickness of the first layer and the thickness of the second layer are independently in a range of about 1 micron to about 99 microns.

107. The water-soluble film of claim 85, wherein the first layer has a thickness in a range of about 1 micron to about 5 microns.

108. The water-soluble film of claim 85, wherein the second layer has a thickness in a range of about 40 microns to about 75 microns.

109. The water-soluble film of claim 85, wherein a film of identical composition and thickness as the first layer has a dissolution time of 300 seconds or less in water having a temperature of 20° C. or less based on the MSTM-205 Dissolution Test Method.

110. The water-soluble film of claim 85, wherein the second layer has an outer surface and wherein the film, when sealed to itself by a first portion of the second layer outer surface being sealed to a second portion of the second layer outer surface, has a water seal strength in a range of about 12 N or more, based on the Seal Strength Test.

111. The water-soluble film of claim 85, wherein the film has a moisture vapor transmission rate of about 100 g/m² or less per 24 hours, based on the Moisture Vapor Transmission Rate test method.

112. A water-soluble unit dose article comprising an outer wall which comprises the water-soluble film of claim 85,
wherein the outer wall comprises an exterior surface and an interior surface;
wherein the exterior surface of the outer wall comprises the first layer of the water-soluble film and the interior surface of the outer wall comprises the second layer of the water-soluble film;
wherein the interior surface of the outer wall defines an interior pouch volume; and
wherein optionally a composition is contained in the interior pouch volume.
